(19) United States
(12) Patent Application Publication
(10) Pub. No.: US 2011/0045274 A1
(43) Pub. Date: Feb. 24, 2011

(54) FUNCTIONALIZED NANOSCALE FIBER FILMS, COMPOSITES, AND METHODS FOR FUNCTIONALIZATION OF NANOSCALE FIBER FILMS

(75) Inventors: Jianwen Bao, Beijing (CN); Zhiyong Liang, Tallahassee, FL (US); Ben Wang, Tallahassee, FL (US); Chun Zhang, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, Tallahassee, FL (US)

(21) Appl. No.: 12/695,766

(22) Filed: Jan. 28, 2010

Related U.S. Application Data
(60) Provisional application No. 61/147,942, filed on Jan. 28, 2009.

(51) Int. Cl. B32B 27/04; B05D 1/18; B32B 37/14

(52) U.S. Cl. 428/297.4; 427/430.1; 156/60; 156/308.6; 977/778

(57) ABSTRACT

Methods are provided for functionalizing nanoscale fibers and for making composite structures from these functionalized nanomaterials. The method includes contacting a network of nanoscale fibers with an oxidant to graft at least one epoxide group to at least a portion of the network of nanoscale fibers. A network of functionalized nanoscale fibers or buckypapers may include carbon nanotubes having a mean length of at least 1 mm and having an epoxide group grafted onto the nanotubes.

### CROSS-REFERENCE TO RELATED APPLICATIONS

This application claims benefit of U.S. Provisional Application No. 61/147,942, filed Jan. 28, 2009, which is incorporated herein by reference.

### STATEMENT REGARDING FEDERALLY SPONSORED RESEARCH OR DEVELOPMENT

This invention was made with U.S. government support under Contract No. FA9550-05-1-0271 awarded by the Air Force Office of Scientific Research. The U.S. government has certain rights in the invention.

### BACKGROUND OF THE INVENTION

This invention relates generally to functionalization of nanoscale fibers, and more particularly to functionalized nanoscale fiber films for use in the production of composite materials.

Carbon nanotubes and nanofibers have both rigidity and strength properties, such as high elasticity, large elastic strains, and fracture strain sustaining capabilities. Such a combination of properties is generally not present in conventional fiber reinforcement materials. In addition, carbon nanotubes and nanofibers are some of the strongest fibers currently known. For example, the Young's Modulus of single-walled carbon nanotubes can be about 1 TPa, which is about five times greater than that for steel (about 200 GPa), yet the density of the carbon nanotubes is about 1.2 g/cm³ to about 1.4 g/cm³. The tensile strength of single-walled carbon nanotubes is generally in the range of about 50 GPa to about 200 GPa. This tensile strength indicates that composite materials made of carbon nanotubes and/or nanofibers could likely be lighter and stronger as compared to current high-performance carbon fiber-based composites.

In addition to their exceptional mechanical properties, carbon nanotubes and nanofibers may provide either metallic or semiconductor characteristics based on the chiral structure of fullerene. Some carbon nanotubes and nanofibers also possess superior thermal and electrical properties such as thermal stability up to about 2800° C. in a vacuum and about 750° C. in air, thermal conductivity about twice as much as that of diamond, and an electric current transfer capacity about 1000 times greater than that of copper wire. Therefore, carbon nanotubes and nanofibers are regarded as one of the most promising reinforcement materials for the next generation of high-performance structural and multifunctional composites.

Thin films or sheets of nanoscale fiber networks, or buckypapers (BP), offer a promising platform to fabricate high-performance nanoscale fiber composites because BPs are easy to handle during fabrication of the composite, and thus, may be incorporated into conventional composites processing to fabricate nanocomposites. However, four main factors tend to affect the performance of nanocomposites: 1) nanoscale fiber dispersion in the composite matrix, 2) nanoscale fiber alignment, 3) interface bonding between the nanoscale fibers and the composite matrix, and 4) aspect ratio of the nanoscale fibers.

A greater amount of interfacial bonding between nanoscale fibers and resin matrices in nanocomposites results in better mechanical performance. Interfacial bonding may be improved by grafting chemical groups on the side-walls of the nanotubes. Different reaction mechanisms may be utilized to graft functional groups on nanoscale fiber sidewalls, including halogenation, hydrogenation, cycloaddition, radical addition, electrophilic addition, addition of inorganic compounds, and directly grafting polymer chains.

Thus, effective functionalization to enhance dispersion in a composite matrix, interfacial bonding with a composite matrix, and functionality of carbon nanotubes and nanofibers may be desirable to successfully transfer their exceptional properties into engineered applications. However, when functionalizing buckypapers, not only should the nanoscale fibers be functionalized, but the structural integrity of the buckypapers should also be maintained. This may be difficult since the preformed network in the buckypaper may weaken in solution and may have difficulty surviving in intense functionalization reaction conditions. In addition, conventional oxidizations undesirably may etch the sidewalls and significantly degrade the mechanical properties of nanotubes or other nanoscale fibers. For instance, fluorination may be effective in modifying nanoscale fiber properties by addition reaction and may have a minimal effect on the mechanical properties of nanoscale fibers, effectively enhancing the properties of the nanoscale fiber reinforced polymers, such as polypropylene. However, fluorination may not be viable for nanoscale fiber-epoxy composites due to the negative effects of the fluorine element on the epoxy curing reaction. In addition, the oxidization and fluorination-derivate functionalizations usually result in a very low yield rate and involve multiple chemical reactions. Therefore, the potential effectiveness for scale-up and mass production using these conventional approaches is very low.

It therefore would be desirable to provide additional methods for functionalizing nanoscale fibers and nanoscale fiber films which reduce or avoid the aforementioned deficiencies. In particular, it would be desirable to provide nanoscale fibers and nanoscale fiber films functionalized for composite applications. It also would be desirable to provide improved methods for functionalizing nanoscale fiber films for composite applications.

### SUMMARY OF THE INVENTION

A method for functionalizing a network of nanoscale fibers is provided. In one aspect, the method comprises contacting the network of nanoscale fibers with an oxidant to graft at least one epoxide group to at least a portion of the network of nanoscale fibers.

In certain embodiments, the contacting is at a temperature ranging from 20° C. to 50° C. In some embodiments, the contacting is for a time period less than 3 hours.

In one embodiment, the network of nanoscale fibers is a buckypaper. In certain embodiments, the nanoscale fibers are carbon nanotubes.

In some embodiments, the oxidant comprises a peroxyacid. In particular embodiments, the peroxyacid is in a peroxyacid solution. In other embodiments, the peroxyacid is present in the peroxyacid solution in an amount ranging from 0.05 wt. % to 30 wt. %.

In certain embodiments, the step of contacting comprises immersing the network of nanoscale fibers into the peroxyacid solution.

In another aspect, a method for making a composite is provided. The method comprises providing a network of functionalized nanoscale fibers and combining the network of functionalized nanoscale fibers with a matrix material to form a composite. At least a portion of the network of functionalized nanoscale fibers has been functionalized by contact with an oxidant.

In certain embodiments, the matrix material comprises a resin. In some embodiments, the resin comprises an epoxy resin. In one embodiment, the network of functionalized nanoscale fibers comprises at least one epoxide group and the at least one epoxide group reacts with the epoxy resin to bond the epoxy resin to the nanoscale fibers.

In another aspect, an article is provided. The article comprises a network of nanoscale fibers, wherein the network comprises nanoscale fibers having at least one epoxide grafted onto at least a portion of the nanoscale fibers.

In certain embodiments, the article further comprises a matrix material dispersed on and/or within the network of nanoscale fibers. In one embodiment, the matrix material comprises an epoxy resin bonded to the at least one epoxide group. In some embodiments, the article has a Young's modulus ranging from 47 GPa to 350 GPa. In other embodiments, the article has a tensile strength ranging from 620 MPa to 3252 MPa.

### BRIEF DESCRIPTION OF THE DRAWINGS

FIG. 1 shows the reaction sequence and functionalization mechanism for carbon nanotubes functionalized with m-CPBA acid.

FIG. 2 illustrates an embodiment of an unstretched and stretched buckypaper labeled with notations for calculating stretching ratio according to Equation 1.

FIG. 3A shows the Raman spectra of MWNT buckypaper samples of Example 1 before functionalization and after functionalization at different functionalization times in a mCPBA/CH₂Cl₂ solution. FIG. 3B is a graph of the degree of functionalization (DOF) versus functionalization time for MWNT buckypaper samples of Example 1.

FIG. 4A shows the Raman spectra of SWNT buckypaper samples of Example 1 before functionalization and after functionalization at different functionalization times in a mCPBA/CH₂Cl₂ solution. FIG. 4B is a graph of the degree of DOF versus functionalization time for SWNT buckypaper samples of Example 1.

FIG. 5A shows the Raman spectra of MWNT BPs functionalized using m-CPBA dichloromethane solutions with different m-CPBA concentrations. FIG. 5B is a graph of the DOF versus m-CPBA concentrations for MWNT buckypaper samples of Example 1.

FIG. 6 is a graph showing the relationship between the weight fraction of the resin in the prepregs and the concentration of epoxy in the solution.

FIG. 7 are SEM images of the fracture surfaces of the resultant composites of MWNT buckypaper with different functionalization times.

FIG. 8 is a graph of the tensile test curves and a chart of the mechanical properties of the pristine, or nonfunctionalized, long MWNT buckypaper composites of Example 1.

FIG. 9 is a graph of the tensile test curves and a chart of the mechanical properties of the pristine, or nonfunctionalized, SWNT buckypaper composites of Example 1.

FIG. 10 is a graph of the tensile test curves and a chart of the mechanical properties of the functionalized, long MWNT buckypaper composites of Example 1.

FIG. 11 shows the epoxy resin-functionalized CNT reaction mechanism as described in Example 1.

FIG. 12 is a graph of the tensile test curves and a chart of the mechanical properties of the functionalized, SWNT buckypaper composites of Example 1.

FIG. 13 compares the tensile curves of the nonfunctionalized and functionalized MWNT and SWNT samples described in Example 1.

FIG. 14 is a schematic illustration of the molecular structures of functionalized SWNTs.

FIG. 15 shows four SEM micrographs comparing the fracture surfaces of the MWNT and SWNT BP composites described in Example 1.

FIGS. 16A-B are graphs showing a comparison of the tensile properties of the resultant BP composites described in Example 1.

FIGS. 17-19 are graphs showing typical tensile stress-strain curves of functionalized CNT sheet/BMI composites made in Example 2.

FIG. 20 is a graph of tensile strength versus Young's Modulus for of CNT sheet/BMI composites made in Example 2 and for UD carbon fiber reinforced composites.

FIG. 21 is a graph of ATR-FTIR spectra of pristine CNTs, functionalized CNTs, and pristine and functionalized aligned (40% stretch) CNT sheet/BMI composites made in Example 2 (Trace a: pristine CNT; Trace b: epoxidation functionalized CNT; Trace c: pristine 40% aligned CNT/BMI nanocomposite; Trace d: functionalized 40% aligned CNT/BMI nanocomposite).

FIG. 22 shows the reaction mechanism for functionalization of CNTs as described in Example 2.

FIG. 23 is a graph of the Raman spectrometer data for the curing mechanism described in Example 2.

FIG. 24A shows the typical stress-strain curves of CNT sheets reinforced BMI nanocomposites made in Example 2 along the nanotube alignment direction. FIG. 24B compares the detailed tensile strength and Young's modulus of these samples.

FIGS. 25A-B are SEM micrographs showing the fracture surface morphology of a functionalized 40% stretch alignment specimen after tensile testing as described in Example 2.

FIGS. 26A-C are graphs showing dynamic mechanical analysis (DMA) results for the samples made in Example 2.

FIG. 27 shows the reaction mechanism between the functionalized CNTs and epoxy resin matrix as described in Example 3.

FIG. 28 is a graph showing the curves of DOF versus functionalization time and m-CPBA concentration for the composites made in Example 3.

FIG. 29A is a graph showing the attenuated total reflection Fourier transform infrared (ATR-FTIR) spectrum comparison of the composites made in Example 3. FIG. 29B is a graph of the Raman spectrometer data for the reaction mechanism described in Example 3.

FIGS. 30A (pristine double-walled nanotube) and 30B (functionalized double-walled nanotube) are HRTEM micrographs of the samples made in Example 3.

FIG. 31 is a graph of tensile stress versus strain for the nanocomposites made in Example 3.

FIG. 32A is a graph showing the load transfer efficiency factor η_{B} logistic fitting to determine η_{B} as described in Example 3; FIG. 32B is a graph showing the relationship of load transfer efficiency and DOF.

FIGS. 33A and 33B re SEM micrographs showing the cross-section of random (33A) and aligned (33B) CNT sheets made in Example 3.

FIG. 34 is a graph showing the typical stress-strain curves of CNT sheet reinforced epoxy nanocomposites with/without alignment and functionalization as made in Example 3.

FIG. 35 are graphs of the tensile strength (FIG. 35A) and Young's modulus (FIG. 35B) of random CNT sheet nanocomposites as made in Example 3.

FIGS. 36A-B are SEM micrographs of the fracture surface morphology of a pristine aligned CNT sheet reinforced epoxy composite specimen as made in Example 3. FIGS. 36C-D are SEM micrographs of the fracture morphology of a functionalized aligned CNT sheet reinforced epoxy composite as made in Example 3. FIG. 36E is the HRTEM image of cross-section of a pristine aligned CNT sheet reinforced epoxy composite as made in Example 3.

FIG. 37A is a graph of the tensile strength of the functionalized and aligned CNT composites made in Example 3 in comparison to state-of-the-art high-strength unidirectional structural CFRP systems; FIG. 37B is a graph showing the failure strain of the functionalized and aligned CNT composites made in Example 3 in comparison to state-of-the-art high-strength unidirectional structural CFRP systems.

### DETAILED DESCRIPTION OF THE INVENTION

Methods have been developed to functionalize nanoscale fibers and nanoscale fiber films for use in composite applications. The developed methods improve interfacial bonding in epoxy resin matrix buckypaper nanocomposites while maintaining the structural integrity of buckypapers. The methods can provide improved dispersion and interface bonding of the nanoscale fibers within a composite matrix, which would considerably increase the load-transfer and performance. In one embodiment, the nanoscale fibers in a functionalized buckypaper react with an epoxy resin matrix during nanocomposite fabrication to improve the interface bonding between the matrix and the nanoscale fibers, thus improving the load-transfer between the nanoscale fibers and resin matrix. Therefore, the mechanical properties of the buckypaper nanocomposites may be effectively enhanced.

The success of the functionalization may facilitate fully realizing potential applications for nanotubes or nanofiber buckypapers for multifunctional applications, providing lightweight high-performance structural materials, electromagnetic interference, and thermal management materials. The methods can be used to produce high-performance composites, electronic device applications, and nanoscale fiber-reinforced epoxy composites. These high-performance buckypaper/epoxy nanocomposites can be used for EMI shielding, thermal management materials, and structural materials applications. Additional applications may include composite applications for aircrafts, such as thermal management for a electronic device package.

In one aspect, a method is provided for functionalizing a network of nanoscale fibers comprising contacting the network of nanoscale fibers with an oxidant. In one embodiment, the oxidant is a peroxyacid. In certain embodiments, the network of nanoscale fibers comprises a buckypaper. By functionalizing a network of nanoscale fibers such as a buckypaper in a moderate peroxyacid reaction, (1) a break down of the network is avoided, (2) epoxide groups are added to the nanoscale fibers to improve interfacial bonding with a composite matrix, and (3) processing of “loose” functionalized nanoscale fibers, which can result in agglomeration of the nanoscale fibers, is avoided.

It is believed that the double bonds of nanoscale fibers are oxidized using a strong oxidant, such as ozone, permanganate, or peroxyacid. Nanoscale fibers reacting with peroxyacid can result in the formation of an epoxide group. The epoxide group on the nanoscale fibers may then be reacted with an epoxy to make epoxy resin matrix-based composites. In particular, the double bonds of unsaturated carbon atoms at the end caps and defective sides of carbon nanotubes are chemically reactive enough to be oxidized using a strong oxidant, or subjected to an additional reaction with free radicals. Hence, peroxyacid may be used to oxidize carbon nanotubes to directly graft epoxide groups at the caps and sidewalls of nanotubes. Advantageously, this functionalization reaction occurs at room temperature in an organic solvent, avoiding intensive reaction conditions and dissolution or destruction of the buckypaper.

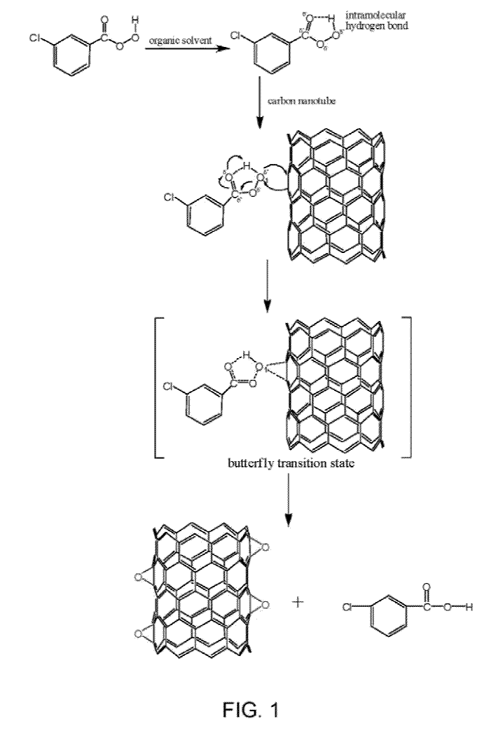

FIG. 1 shows a functionalization mechanism for carbon nanotubes functionalized with m-CPBA acid. The m-CPBA forms an intramolecular hydrogen bond in an organic solvent, and the m-CPBA molecular is polarized at a high degree to result in the electrophilic oxygen atom “1” being able to attack a carbon atom on the nanotube, which is nucleophilic, to form a transition state—the “butterfly transition state.” In the transition state, the “0-0” bond is the weakest, and is usually the first bond broken, forming the C—O with the carbon atom and a new “C═O.” The “H” atom is transferred to the “O” atom on the original C═O to simultaneously form a new “OH” group. So, the oxygen atom “1” is separated from m-CPBA to form an epoxide group with the nanotube. “—CL,” an electron-withdrawing group, is located at the meta-position of m-chloroperoxylbenzonic acid, so the acid's oxidizability is stronger. Thus, carbon nanotubes may be oxidized at room temperature. After oxidization, the double bonds on the sidewall of carbon nanotubes are transferred into epoxide groups, which results in changing the sp² hybridized orbital into an sp³ hybridized orbital in the reacting carbon atoms.

Without being bound by a particular theory, covalent functionalization is believed to create defects in nanotube lattice, which also lowers electrical and thermal conductivity of the carbon nanotubes (CNTs). Hence, covalent functionalization is a double-edged sword for realizing high mechanical properties of CNT reinforced composites. Thus, the degree of functionalization should balance the increase in the interfacial bonding with a decrease in mechanical properties of CNTs to maximize the mechanical properties in the resultant composites. Specific degrees of functionalization (DOF) that can improve interfacial bonding without unduly sacrificing the intrinsic mechanical properties of CNTs.

### Methods for Functionalizing Networks of Nanoscale Fibers and Composite Production

In certain embodiments, the method of functionalizing a network of nanoscale fibers comprises contacting the network with an oxidant. As used herein, the terms “functionalization” and “functionalize” refer to the creation of functional groups, cross-links, vacancies, knock-on carbon atoms, or pentagon/heptagon Stone-Wales defects, as well as various interconnections or junctions, in and/or among the nanoscale fibers.

In certain embodiments, the oxidant is ozone, a permanganate, or a peroxyacid. In some embodiments, the oxidant is a peroxyacid solution. Suitable examples of the peroxyacid solution include meta-chloromethaneperoxylbenzoic acid (m-CPBA) or m-chloroperoxybenzoic acid or similar peroxides (e.g., more reactive peroxides). In some embodiments, a peroxyacid is present in a solution in an amount ranging from 0.05 wt. % to 30 wt. % may be contacted with nanoscale fibers to functionalize them. A suitable solvent for the peroxyacid solution includes dichloromethane, chloroform, benzene, methylene chloride, or other organic solvents. In other embodiments, the solvent may include acetone or alcohol.

In one embodiment, the method of functionalizing a network of nanoscale fibers comprises immersing or dipping a buckypaper into a peroxyacid solution. In particular embodiments, the method may include functionalization reactions at room temperature (22-25° C.) without stirring and refluxing. Thus, the reaction conditions of the improved methods are moderate and allow for ease in scaling-up the process.

In other embodiments, the network of nanoscale fibers is contacted with an oxidant at a temperature ranging from 20° C. to 50° C. The network of nanoscale fibers may contact the oxidant at a temperature higher than 50° C. if such a step does not break-up or destroy the network of nanoscale fibers.

In certain embodiments, the oxidant is contacted with the network of nanoscale fibers for less than 3 hours.

In one embodiment of a functionalized nanoscale fiber film, substantially all or all nanoscale fibers are functionalized.

In some embodiments, the functionalized nanoscale films are further joined with another material, such as a matrix material, to form a composite. In some embodiments, the functionalized buckypapers undergo composite fabrication processes for making final composites, such as vacuum-assisted resin transfer molding (VARTM), resin transfer molding (RTM), vacuum infusion process (VIP), autoclave/prepreg process, carbon-carbon impregnation, or a combination thereof.

In certain embodiments, the method of making a composite further comprises impregnating the functionalized buckypaper with a resin and then B-stage curing the resin to form a prepreg.

In one embodiment, the method of making a composite includes grafting an epoxide group on carbon nanotubes using a peroxyacid. Without being bound by any particular theory, the functionalization of nanoscale fibers with an epoxide group is believed to results in greater dispersion of the nanoscale fibers within the epoxy resin composite matrices due to the ease of bonding between the epoxide group and the epoxy resin.

In some embodiments, the method of making a composite further comprises mechanically stretching the network of nanoscale fibers in a first direction before incorporation of the network with a matrix material. The network of nanoscale fibers can be mechanically stretched to align the nanoscale fibers before or after functionalization of the nanoscale fibers. As used herein, “mechanically stretching” or “mechanically stretch” refers to treatment of sheets of networks of fibers or buckypapers by pulling or applying mechanical loads to the sheets in opposed or offset directions.

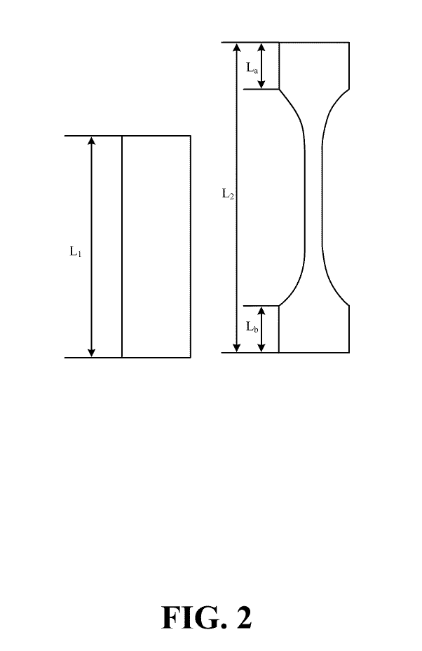

In one embodiment, a buckypaper is stretched using a Shimadzu machine. In such embodiments, the stretching ratio (or stretch ratio, Δ%) of BP samples was calculated by Equation 1.

$$Δ \% = \frac{{L}_{2 -} {L}_{1}}{{L}_{1} - {L}_{a} - {L}_{b}} \times 100 \% . \qquad Equation 1$$

Where L₁, and L₂ are the lengths of a BP strip before and after stretching, Lₐ and L_{b} are the lengths of the segments held by the stretching clamp as shown in FIG. 2. It should be understood that Equation 1 can be used as stated or modified to suit the buckypaper shape and the particular process used to stretch the buckypaper.

The network of nanoscale fibers may be substantially devoid of a liquid during the mechanical stretching. As used herein, “substantially devoid of a liquid” means the network comprises liquid in an amount less than 10 wt. % of the network, typically less than 5 wt. %, 1 wt. %, 0.1 wt. %, or 0.01 wt. %.

In certain embodiments, a buckypaper and a supporting media (e.g., a polymeric film such as a polyethylene film) are stretched together to align the nanoscale fibers of the buckypaper.

### Functionalized Nanoscale Fiber Films

As used herein, the term “nanoscale fibers” refers to a thin, greatly elongated solid material, typically having a cross-section or diameter of less than 500 nm. In certain embodiments, the nanoscale fibers are single-walled carbon nanotubes (SWNTs), multiple-walled carbon nanotubes (MWNTs), carbon nanofibers (CNFs), or mixtures thereof. Carbon nanotubes and carbon nanofibers have high surface areas (e.g., about 1,300 m²/g), which results in high conductivity and high multiple internal reflection. In a preferred embodiment, the nanoscale fibers comprise or consist of carbon nanotubes, including SWNTs, MWNTs, or combinations thereof. SWNTs typically have small diameters (˜1-5 nm) and large aspect ratios, while MWNTs typically have large diameters (˜5-200 nm) and small aspect ratios. CNFs are filamentous fibers resembling whiskers of multiple graphite sheets.

In certain embodiments, the nanoscale fibers comprise carbon nanotubes having a mean length of at least 1 millimeter (available from Nanocomp Technologies, Concord, N.H.) (“millimeter-long” CNTs). Without being bound by a particular theory, it is believed that the millimeter-long CNTs have a large aspect ratio up to the order of 10,000-100,000, resulting in more effective transfer of load to improve the mechanical properties of nanocomposites. In addition, these long nanotubes may be aligned more easily in yarns and buckypapers by mechanical methods, such as a stretching method, which can increase the strength properties of nanocomposites. Moreover, higher aspect ratio nanotubes easily form networks in composites to increase electrical and thermal conductivity.

As used herein, the terms “carbon nanotube” and the shorthand “nanotube” refer to carbon fullerene, a synthetic graphite, which typically has a molecular weight between about 840 and greater than 10 million grams/mole. Carbon nanotubes are commercially available, for example, from Unidym Inc. (Houston, Tex. USA) or Carbon Nanotechnologies, Inc. (Houston Tex. USA), or can be made using techniques known in the art.

The nanotubes optionally may be opened or chopped, for example, as described in U.S. Pat. No. 7,641,829 B2.

As used herein, the term “nanoscale film” refers to thin, preformed sheets of well-controlled and dispersed porous networks of SWNTs, MWNTs, CNFs, or mixtures thereof. Films of carbon nanotubes and nanofibers, or buckypapers, are a potentially important material platform for many applications. Typically, the films are thin, preformed sheets of well-controlled and dispersed porous networks of SWNTs, MWNTs, carbon nanofibers CNFs, or mixtures thereof. The carbon nanotube and nanofiber film materials are flexible, light weight, and have mechanical, conductivity, and corrosion resistance properties desirable for numerous applications. The film form also makes nanoscale materials and their properties transferable to a macroscale material for ease of handling.

The nanoscale fiber films be made by essentially any suitable process known in the art. In one embodiment, the buckypaper is made by stretching or pushing synthesized nanotube “forests” to form sheets or strips. In another embodiment, the buckypaper is made by consolidation of syntheses nanotube aerogel to form film membranes.

In some embodiments, the nanoscale fiber film materials are made by a method that includes the steps of (1) suspending SWNTs, MWNTs, and/or CNF in a liquid, and then (2) removing a portion of the liquid to form the film material. In one embodiment, all or a substantial portion of the liquid is removed. As seen herein, “a substantial portion” means more than 50%, typically more than 70, 80%, 90%, or 99% of the liquid. The step of removing the liquid may include a filtration process, vaporizing the liquid, or a combination thereof. For example, the liquid removal process may include, but is not limited to, evaporation (ambient temperature and pressure), drying, lyophilization, heating to vaporize, or using a vacuum.

The liquid includes a non-solvent, and optionally may include a surfactant (such as Triton X-100, Fisher Scientific Company, N.J.) to enhance dispersion and suspension stabilization. As used herein, the term “non-solvent” refers to liquid media that essentially are non-reactive with the nanotubes and in which the nanotubes are virtually insoluble. Examples of suitable non-solvent liquid media include water, and volatile organic liquids, such as acetone, ethanol, methanol, n-hexane, benzene, dimethyl formamide, chloroform, methylene chloride, acetone, or various oils. Low-boiling point liquids are typically preferred so that the liquid can be easily and quickly removed from the matrix material. In addition, low viscosity liquids can be used to form dense conducting networks in the nanoscale fiber films.

For example, the films may be made by dispersing nanotubes in water or a non-solvent to form suspensions and then filtering the suspensions to form the film materials. In one embodiment, the nanoscale fibers are dispersed in a low viscosity medium such as water or a low viscosity non-solvent to make a suspension and then the suspension is filtered to form dense conducting networks in thin films of SWNT, MWNT, CNF or their mixtures. Other suitable methods for producing nanoscale fiber film materials are disclosed in U.S. patent application Ser. No. 10/726,074, entitled “System and Method for Preparing Nanotube-based Composites;” U.S. Patent Application Publication No. 2008/0280115, entitled “Method for Fabricating Macroscale Films Comprising Multiple-Walled Nanotubes;” and U.S. Pat. No. 7,459,121 to Liang et al.

Additional examples of suitable methods for producing nanoscale fiber film materials are described in S. Wang, Z. Liang, B. Wang, and C. Zhang, “High-Strength and Multifunctional Macroscopic Fabric of Single-Walled Carbon Nanotubes,” Advanced Materials, 19, 1257-61 (2007); Z. Wang, Z. Liang, B. Wang, C. Zhang and L. Kramer, “Processing and Property Investigation of Single-Walled Carbon Nanotube (SWNT) Buckypaper/Epoxy Resin Matrix Nanocomposites,” Composite, Part A: Applied Science and Manufacturing, Vol. 35 (10), 1119-233 (2004); and S. Wang, Z. Liang, G. Pham, Y. Park, B. Wang, C. Zhang, L. Kramer, and P. Funchess, “Controlled Nanostructure and High Loading of Single-Walled Carbon Nanotubes Reinforced Polycarbonate Composite,” Nanotechnology, Vol. 18, 095708 (2007).

In certain embodiments, the nanoscale fiber films are commercially available nanoscale fiber films. For example, the nanoscale fiber films may be preformed nanotube sheets made by depositing synthesized nanotubes into thin sheets (e.g., nanotube sheets from Nanocomp Technologies Inc., Concord, N.H.). MWNT sheets from Nancomp have substantial nanotube entanglements and possible interconnection through Nanocomp's proprietary floating catalyst synthesis and aerogel condense method.

Theses MWNT sheets can reach up to a meter long and are commercially available. which makes them practical for manufacturing bulk composites.

In various embodiments, good dispersion is realized in buckypapers materials, which assists the production of high nanoscale fiber content (i.e., greater than 20 wt. %) buckypaper for high performance composites materials.

The nanotubes and CNFs may be randomly dispersed, or may be aligned, in the produced films. In one embodiment, the nanoscale fibers may be ground with a quantity of benzene before being dispersed. In one embodiment, the mixture may be dispersed using ultrasonic processing. In one embodiment, the fabrication method further includes aligning the nanotubes in the nanoscale film. For example, this may be done using in-situ filtration of the mixtures in high strength magnetic fields, as described for example, in U.S. Patent Application Publication No. 2005/0239948 to Haik et al.

In various embodiments, the films have an average thickness from about 5 to about 100 microns thick with a basis weight (i.e., area density) of about 20 g/m² to about 50 g/m². In one embodiment, the buckypaper is a thin film (approximately 20 μm) of nanotube networks.

### Nanoscale Fiber Composites and Uses Thereof

Matrix Material

Composite materials are provided that comprise nanoscale fibers and a matrix material. Suitable matrix materials include epoxy resins, phenolic resins, bismaleimide (BMI), polyimide, thermoplastic resins (e.g., nylon and polyetheretherketone resins), and other polymers.

In certain embodiments, the matrix material may comprise a B-stage cured resin (e.g., an epoxy, a polyimide, a bismaleimide, a phenolic resin, or a cyanate) such that the composite material comprises a prepreg.

Composites

In certain embodiments, composites comprising a network of functionalized nanoscale fiber films have a Young's modulus ranging from 47 GPa to 350 GPa. In some embodiments, composites comprising a network of functionalized nanoscale fiber films have a Young's modulus greater than 350 GPa. In other embodiments, the composites comprising a network of functionalized nanoscale fiber films article have a tensile strength ranging from 620 MPa to 3252 MPa. In still other embodiments, the composites comprising a network of functionalized nanoscale fiber films article have a tensile strength greater than 3252 MPa.

The high-performance buckypaper nanocomposites can be used for EMI shielding, thermal management and structural materials applications. Representative applications include composite applications for aircraft and thermal management for electronic device package. Other applications may include lightning strike protection, other lightweight structural materials applications, and electronic and energy applications, such as high-conducting thin film and powerful and efficient battery and fuel cell electrodes. High-performance buckypaper materials may also be used to develop lightweight-conducting films and current-carrying materials for electronic products.

Other embodiments are further illustrated below in the examples which are not to be construed in any way as imposing limitations upon the scope of this disclosure. On the contrary, it is to be clearly understood that resort may be had to various other embodiments, modifications, and equivalents thereof which, after reading the description therein, may suggest themselves to those skilled in the art without departing from the scope of this disclosure and the appended claims.

### Example 1

This example illustrates an embodiment for making a composite comprising a functionalized buckypaper. The buckypaper was functionalized by the following method: Five parts (by weight) m-CPBA (purchased from Sigma Aldrich, 75 wt. %, used as received) were dissolved in 100 parts solvent (dichloromethane, chloroform, or benzene); 0.5 parts (by weight) buckypaper (MWNT (having a mean length of at least 1 millimeter) or SWNT film sheets from Nanocomp (Concord, N.H.)) was immersed in the solution for different periods of time at room temperature (22-25° C.) at the static state. The functionalized buckypapers were removed and washed with alcohol (reagent alcohol, 20% (v/v), Fisher Scientific) at least three times. Then, the buckypaper was transferred to a vacuum oven are dried at 80° C. for 2 hours under 28 in Hg vacuum.

After functionalization, the degree of functionalization (DOF) of the buckypaper samples was characterized by a Raman spectrometer. An in Via Raman Microscope (Renishaw Inc.) was used for the spectrum analysis. The major parameters were laser wavelength: 785 nm, laser gate: 1200 l/mm, exposure time: 100 s, and laser power level: 0.2%. In a Raman spectrum of a carbon nanotube, the axial vibrations of the sp² and sp³ structures of the carbon atoms are referred to as the G band and D band, respectively. After functionalization, some sp² hybridized orbitals were changed to sp³ hybridized orbitals, which led to a noticeable increase of D band intensity and a reduction of G band intensity. In addition, the ratio of D band and G band intensity was a good indication of DOF.

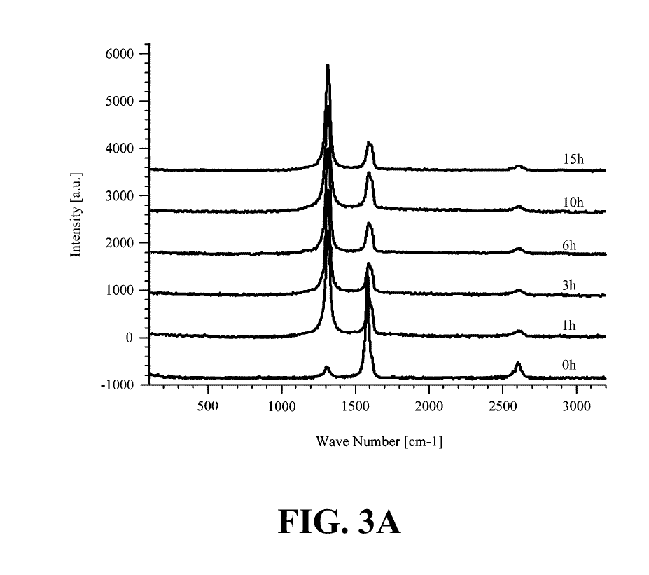

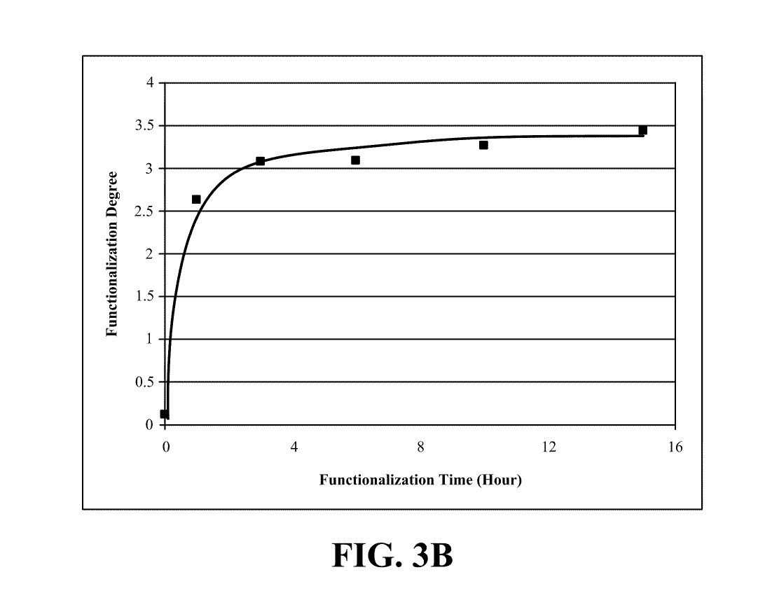

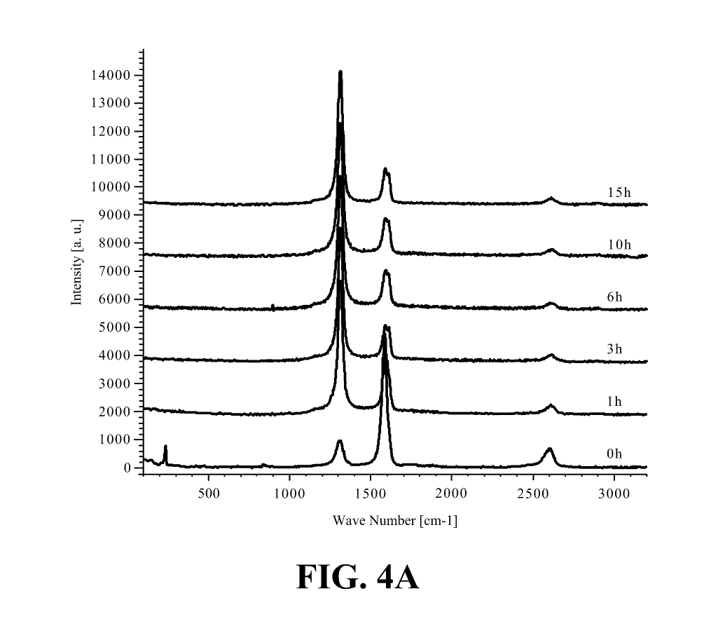

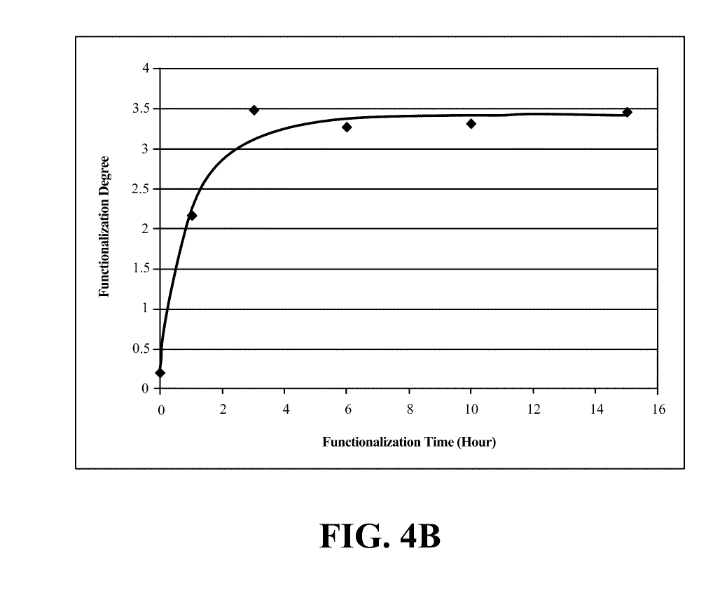

FIG. 3A shows the Raman spectra of MWNT buckypaper samples before functionalization and after functionalization at different functionalization times in a mCPBA/CH₂Cl₂ solution. The intensity of the D band and the G band was reversed with the increase of functionalization time. The ratio of D band and G band intensity, or DOF, of the MWNTs in the buckypaper samples almost reached the maximum value after a three-hour functionalization reaction at room temperature. The same result was found for the SWNT buckypaper material, where the functionalization reaction led to the maximum DOF with a three-hour reaction, as shown in FIG. 4. Comparing the Raman spectra and DOFs of functionalized MWNT and SWNT BP (FIGS. 3 and 4), the functionalization degree of SWNT buckypapers was slightly higher than those of MWNT buckypapers, which indicates that the SWNTs were easier to functionalize than the MWNTs. This difference likely was due to a high reactivity of the small diameters of SWNTs. Smaller-diameter nanotubes have a smaller curvature radius, which can usually result in a bigger pyramidalization angle, called the “curvature-induced pyramidalization angle.” The curvature-induced pyramidalization and misalignment of the π-orbitals of the carbon atoms induces a local strain. Carbon nanotubes were likely to be more reactive than a flat grapheme sheets (its pyramidalization angle is zero). In addition, smaller-diameter nanotubes were likely more reactive than larger-diameter nanotubes, such as MWNTs.

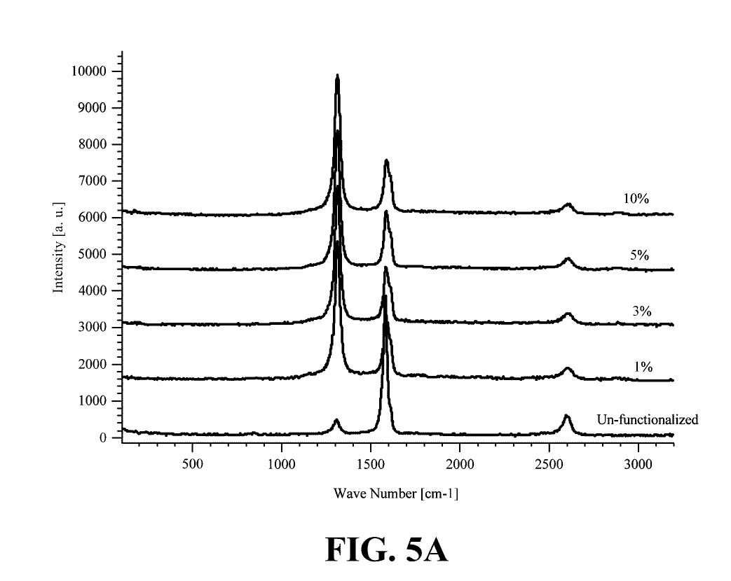

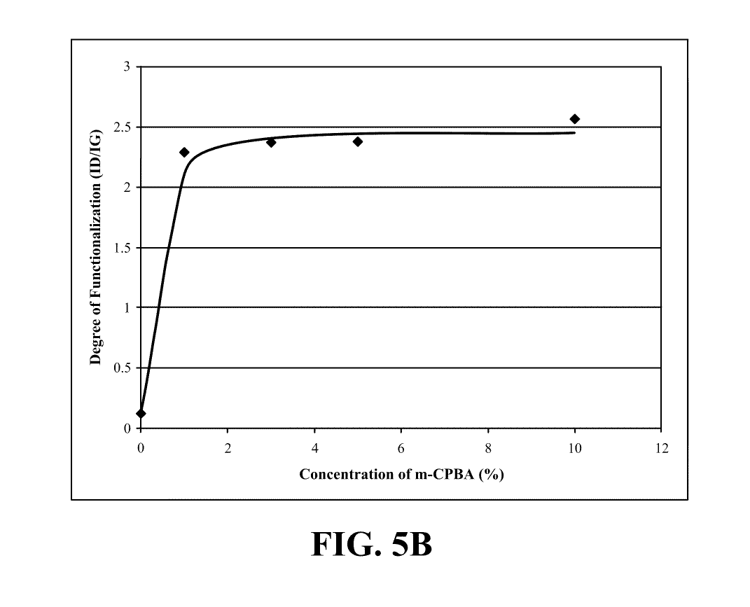

FIG. 5A shows the Raman spectra of MWNT BPs functionalized using m-CPBA dichloromethane solutions with different m-CPBA concentrations. The functionalization time was fixed for three hours for all of the samples. The resultant DOFs were almost the same for the 3%, 5%, and 10% m-CPBA concentration cases. The 1% concentration had a relatively low DOF.

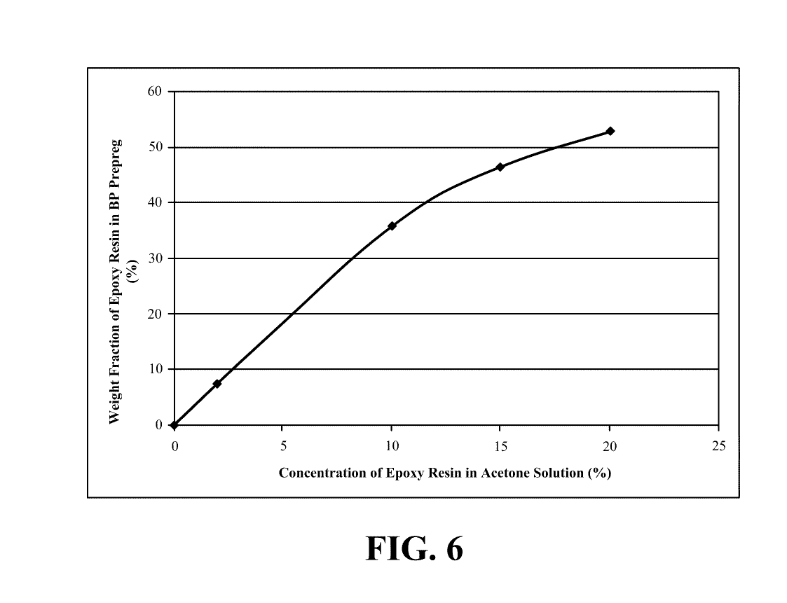

The buckypapers were then made into prepregs. Epoxy resin (Epon 862) and curing agent W (diethyltoluenediamines) from E.V. Rubber Inc. were mixed at a weight ratio of 100 Epon 862 epoxy to 26.4 curing agent W. The mixture was dissolved in acetone to get an epoxy resin solution. The functionalized buckypapers were immersed into the epoxy resin solution for 2-5 minutes and then removed. FIG. 6 shows the relationship between the weight fraction of the resin in the prepregs and the concentration of epoxy in the solution. To realize a high weight fraction of buckypaper in the resulting composites, the concentration of the epoxy resin solution used was 15%-20%.

After evaporating the acetone and B-stage curing the resin in a vacuum oven at 70±10° C. for 30 minutes at a vacuum degree lower than 1 psi to make buckypaper/epoxy prepregs, 10 layers of the impregnated buckypaper sheets were stacked together, and hot pressed using a hot press (Model 3925, Carver Inc). The final composite sample was cured at 177° C. for 2.5-3 hours at 1-20 MPa pressure.

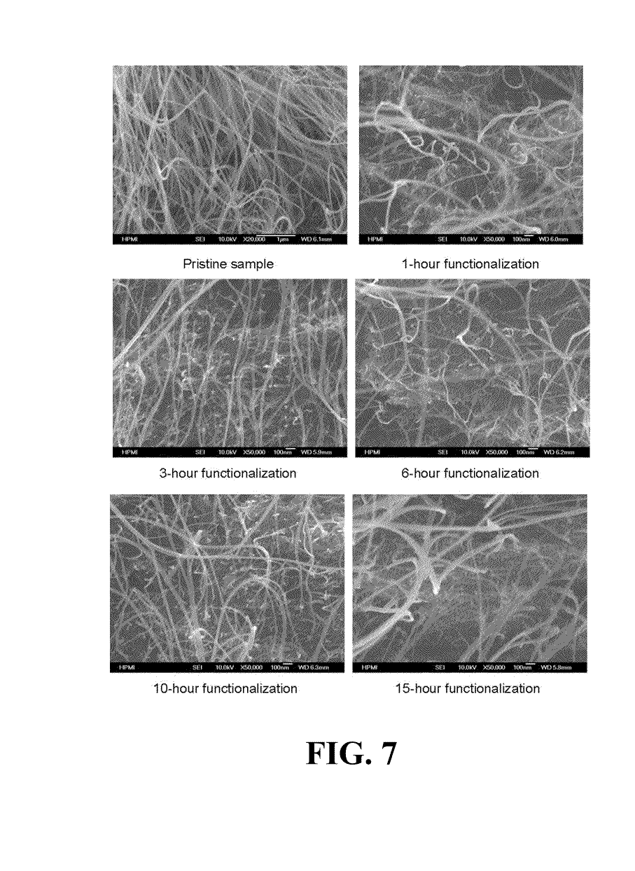

A JEOL JSM-7401F Field Emission Scanning Microscope (JEOL USA, Inc.) was used to observe the samples. Samples for SEM experiments were sputter-coated for 60 s at a current of 5 mA. FIG. 7 shows SEM images of the fracture surfaces of the resultant composites of MWNT buckypaper with different functionalization times. In the pristine buckypaper composite sample, almost all of the millimeter-long MWNT carbon nanotubes were pulled from the epoxy resin matrix, but most carbon nanotubes were broken in the functionalized BP composites. No noticeable difference was seen among the samples with different functionalization times, indicating that a short functionalization time can be used.

### Mechanical Properties

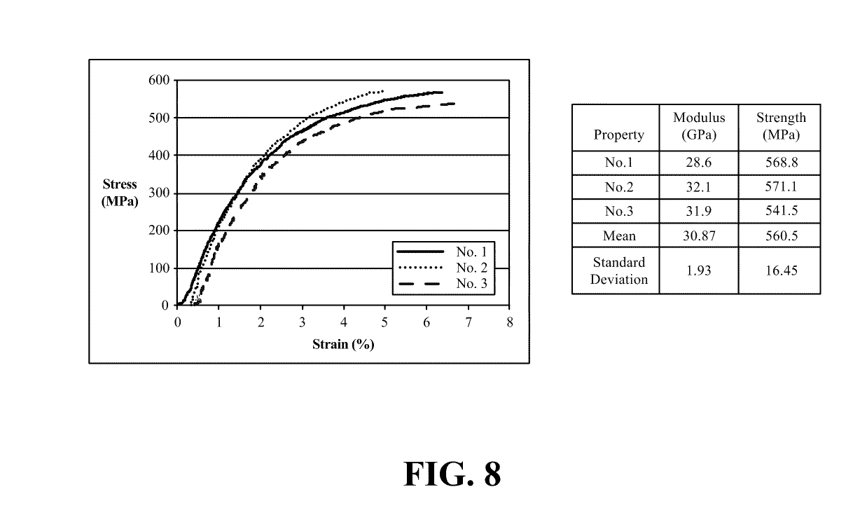

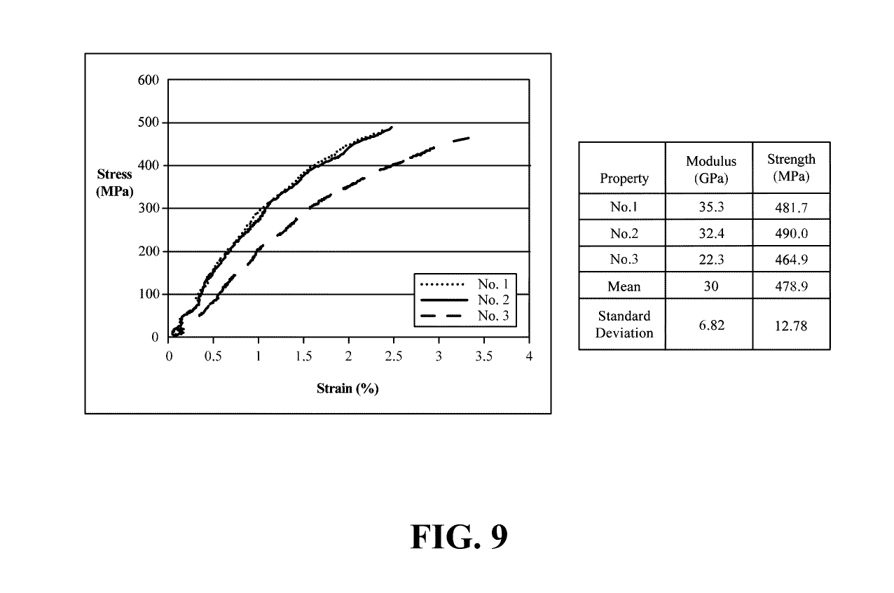

The composite samples were tested using a Shimadzu material testing machine (Kyoto, Japan). The testing was conducted in accordance with ASTM D 638-03. Dog-bone shaped samples were tested. FIGS. 8 and 9 show the tensile test curves and the mechanical properties of the pristine, or nonfunctionalized, long MWNT and SWNT buckypaper composites. The buckypaper weight fractions of the MWNT and SWN™ composites were 42.7% and 40.7%, respectively. The modulus values of MWNT and SWNT buckypaper composites were almost at the same level, and the tensile strength of the MWNT buckypaper composites was about 15% higher than that of the SWNT composites. The break strain of the MWNT composites was about twice as high as that of the SWNT composites. The tensile strain-stress curves of MWNT composites showed a noticeable yield stage. The yield stage phenomenon indicated that the long MWNT carbon nanotubes were pulled out from the matrix progressively due to weak interfacial bonding. The SWNT nanotubes may be relatively short and likely did not have such progression pulling out as a failure mode.

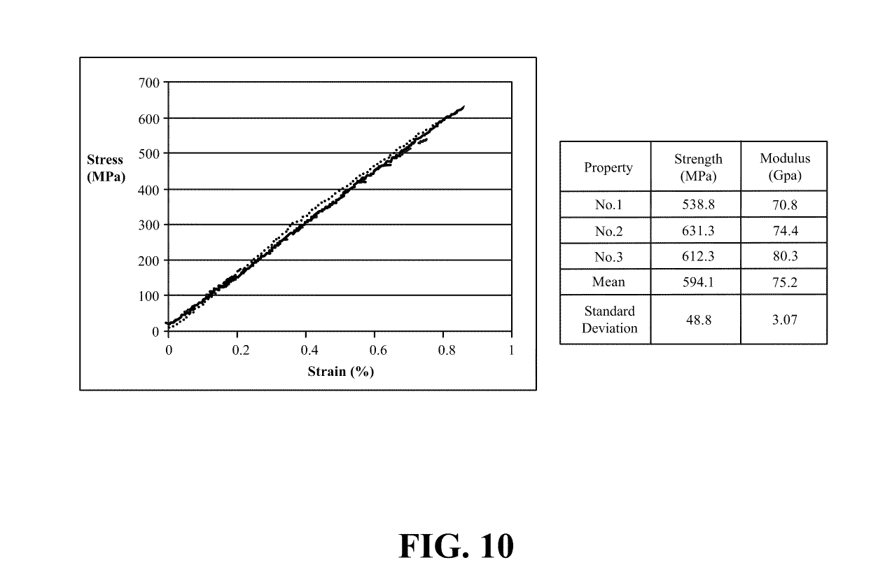

After functionalization, the mechanical properties of the MWNT buckypaper composites noticeably improved, as shown in FIG. 10. Here, the nanotube weight fractions of the functionalized MWNT and SWNT buckypaper composites were 43.7% and 45.5%, respectively. The tensile modulus of the functionalized MWNT buckypaper composites improved by about 250%, and its tensile strength also improved. The strain-stress curve of the functionalized MWNT composites was almost a straight line, which meant that the tensile fracture was an elastic and brittle fracture. There was no yielding stage for the functionalized buckypaper composites (see FIG. 9). Instead of the pulling-out failure mode of the nonfunctionalized MWNT composites due to poor interfacial bonding, the functionalized nanotubes were broken in the buckypaper composite samples, showing a brittle fracture mode and indicating better interfacial bonding and load transfer.

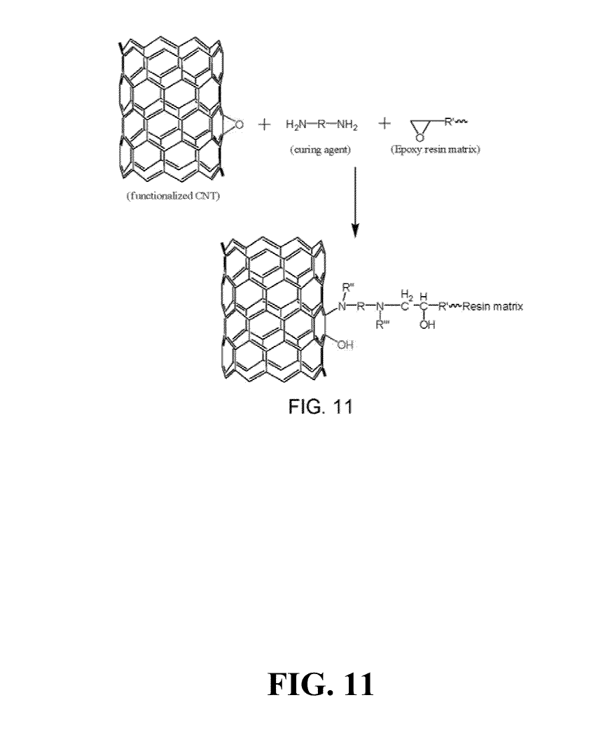

For functionalized millimeter-long MWNT buckypapers, epoxide groups formed on the sidewalls of the nanotubes. Possibly, the epoxide groups reacted with the curing agent to form covalent bonds during curing, as shown in FIG. 11. Covalent bonds formed between the functionalized nanotubes and epoxy resin matrix, which resulted in a significant improvement of interfacial bonding and load transfers between the nanotubes and resin matrix. Breaking the covalent bond was an elastic failure mode and may lead to breaking of the nanotubes, since the nanotubes were a major load carrier in the composites.

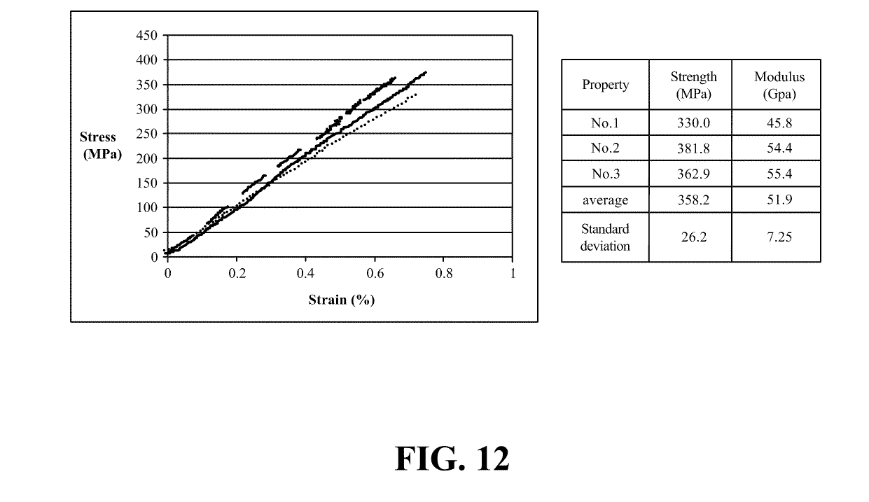

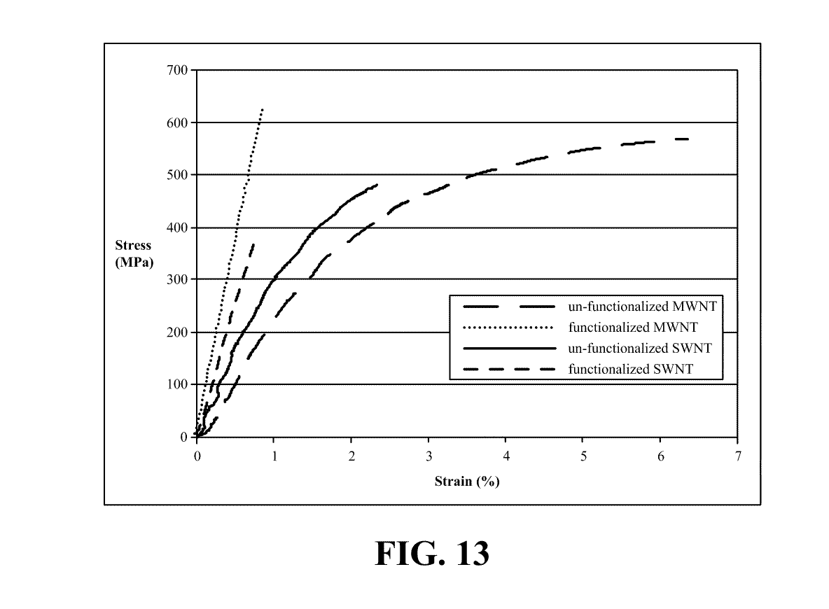

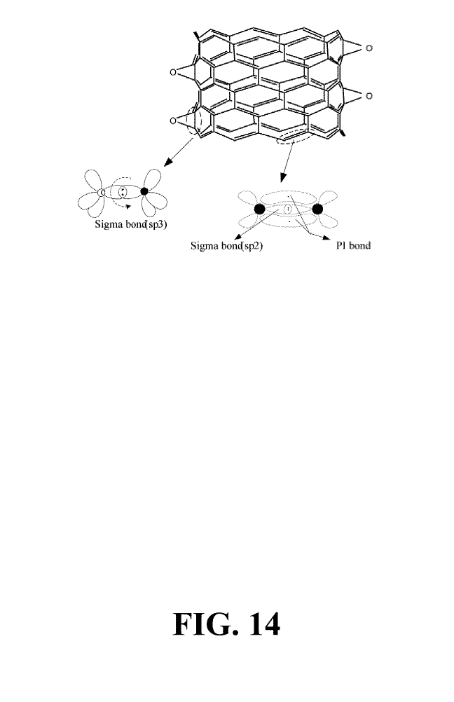

As shown in FIGS. 12 and 13, the tensile modulus of the functionalized SWNT buckypapers composites also increased, but their enhancement was not as high as that of the MWNT composites. In contrast, the tensile strength of the long SWNT buckypaper composites was decreased after functionalization. The possible reason for reduced mechanical property enhancement of the functionalized SWNT buckypaper composites was that the perfect molecular structure of the SWNT was damaged by functionalization. During functionalization, some sp² hybrid orbits likely were changed to sp³ hybrid orbits, resulting in the damage of the molecular perfection of the SWNTs, hence, a decrease in the mechanical properties. This damage could have been significant for the SWNTs because SWNTs have only one layer wall (shown as FIG. 14). Any sp³ structures would weaken the sides on an SWNT nanotubes, hence, leading to significant property degradation of the nanotubes after functionalization.

As previously mentioned, SWNTs actually have higher DOFs as compared to MWNTs, which means that more weak sides on the SWNTs could lead to greater mechanical property (e.g., strength) degradation. In contrast, the functionalization only damaged the outermost layer walls of the MWNTs. The functionalized MWNTs can possibly still hold most of their original mechanical properties after functionalization. Therefore, the enhancement of the modulus of the functionalized SWNT composites is much lower; its tensile strength was decreased due to possible SWNT mechanical property degradation.

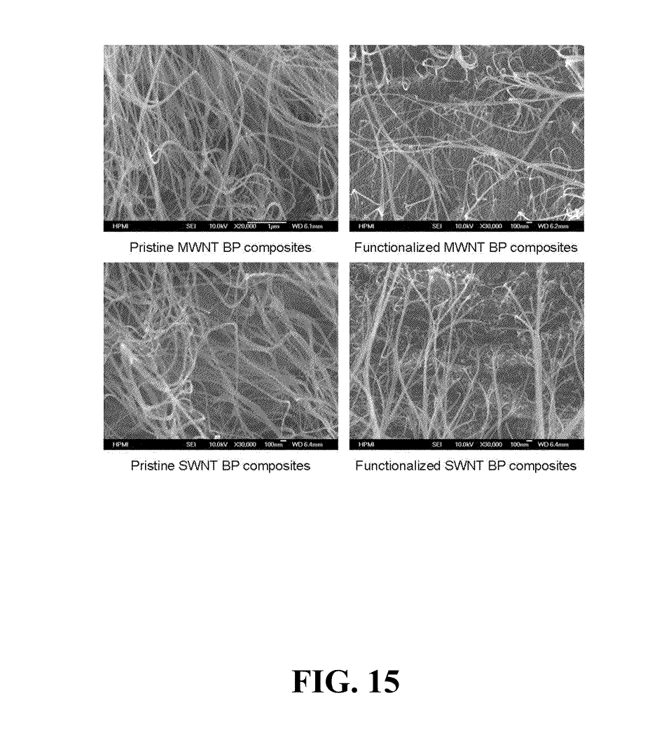

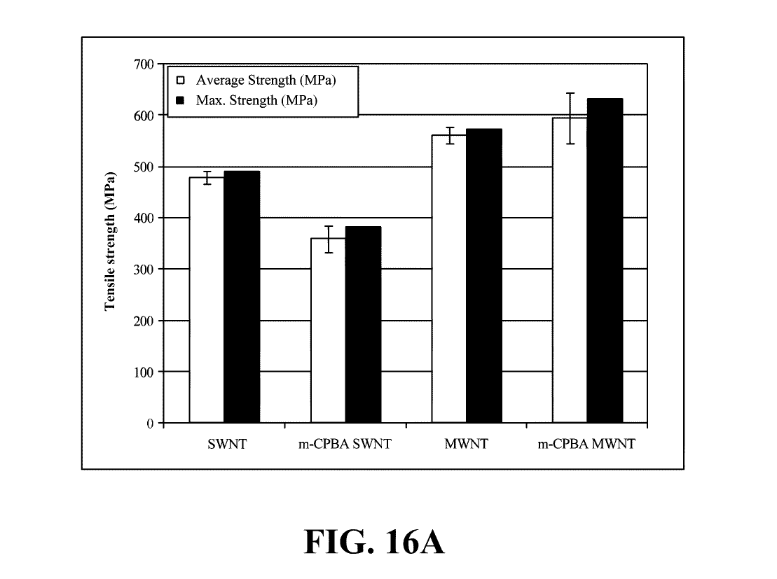

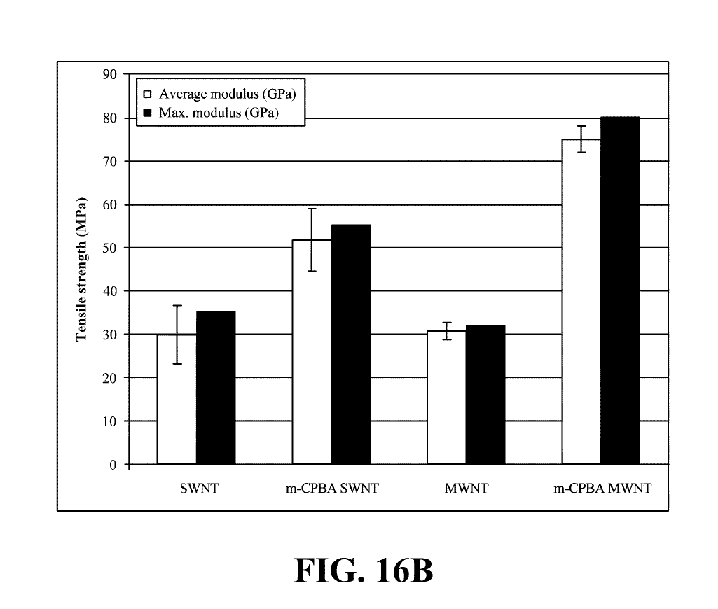

FIG. 15 shows a comparison of the fracture surfaces of the MWNT and SWNT BP composites. Improvements in interfacial bonding and nanotube breaks can be seen for both functionalized MWNT and SWNT buckypaper composites. FIG. 16 provides a comparison of the tensile properties of the resultant BP composites. The effects of functionalization and nanotube-type mechanical properties were seen in these micrographs. The functionalized MWNT buckypaper composites realized high mechanical performance compatible to carbon fiber fabric composites for structural applications.

In summary, the interfacial bonding of nanotubes and epoxy resin in long nanotube thin film or buckypaper (BP) composites were improved by using buckypapers functionalized with m-CPBA at room temperature to realize epoxide group grafting on the nanotube surface. During functionalization, π bonds of the nanotubes were oxidized by m-CPBA to form epoxide groups on the sidewalls of the nanotubes. These epoxide groups reacted with the curing agent of epoxy resin, such as an amine group, to cross-link with the epoxy matrix. Raman spectrum analysis revealed the success in grafting epoxide groups on long carbon nanotubes in buckypapers at room temperature requiring a relatively short reaction time (less than three hours), without damaging the buckypapers' integrity. Functionalized long nanotube buckypapers were impregnated using epoxy resin to make a buckypaper/epoxy prepregs. The buckypapers were used to fabricate highly nanotube-loaded nanocomposite samples. The resultant nanocomposites with 43.7 wt. % MWNT showed a 80 GPa modulus and 631 MPa strength, which are comparable to aerospace-grade carbon fiber fabricate composites for structural applications. Improvements in the interfacial bonding of functionalized composites were also observed at the fracture surfaces of the samples. The improvement of interfacial bonding and loading transfer are well-evidenced by property improvements, nanotube breaks, good bonding at the fracture surfaces, and failure mode changes. The developed functionalization method and composite fabrication technique have the potential for scaling up industrial applications.

### Example 2

Functionalized CNT sheets were used to reinforce BMI composites. The mechanical properties of the resultant CNT sheet/BMI composites were normalized to 60 vol. % nanotube volume content and compared with the unidirectional (UD) carbon fiber composites. These composites demonstrated mechanical properties beyond aerospace-grade unidirectional carbon fiber composites for structural applications.

Materials and Functionalized MWNT sheet/BMI nanocomposite fabrication

Randomly oriented MWNT sheets (supplied by Nanocomp Technologies Inc.) were mechanically stretched using an AGS-J Shimadzu machine to substantially improve nanotube alignment (e.g., up to 80% along the stretching or alignment direction). The stretching ratio of the MWNT sheets was calculated using Equation 1.

The crosshead speed during stretching was 0.5 mm/min. The resin system used was Cytec's BMI 5250-4 resin, which contains three components, 4, 4′-bismaleimidodiphenylmethane, o,o′-diallyl bisphenol A and BMI-1, 2-tolyl. According to a phenol-epoxy curing mechanism, the active epoxy groups can react with hydroxyl groups of o,o′-diallyl bisphenol A. Hence, epoxidation functionalized CNTs were used to realize covalent bonding with BMI resin matrices. This functionalization method was suitable for tailoring the degree of functionalization (DOF) using a gentle reaction condition to avoid damage of preformed nanotube alignment and sheet structural integrity.

Peroxide acid (m-chloroperoxybenzoic acid, m-CPBA) was used to treat MWNTs and introduce an epoxy ring on the structure of the MWNTs. Both randomly dispersed and aligned CNT sheets were treated with a m-CPBA solution (at a 0.4 wt. % to 3 wt. % concentration) to realize a tailored 4% functionalization degree to minimize CNT structure damage and composite mechanical property degradation. Specifically, the aligned CNT sheets were placed in a m-chloroperoxybenzoic acid (m-CPBA)/dichloromethane solution for epoxidation functionalization, and then washed using dichloromethane to remove residual m-CPBA. The functionalized CNT sheets were placed into the vacuum oven at 80° C. for 30 min to evaporate the residual dichloromethane.

Then, CNT sheets were impregnated with BMI 5250-4 resin solution to make individual CNT prepreg sheets with approximately 60 wt. % nanotube concentration or loading. The BMI resin solution was prepared in the same manner as the BMI resin solution. The concentration of BMI resin in the solution was adjusted to less than 10 wt. % to ensure low viscosity for facilitating impregnation. The solvent used was acetone. The prepregging process was a solution impregnation process. The residual solvent (acetone) was removed under 80° C. in the vacuum oven for 2 hours to make BMI/CNT sheets prepreg. Six prepreg layers were stacked together and cured by the hot-press with 1-20 MPa pressure following the curing cycle: 375° F. for 4 hours and then 440° F. for 2 hours. The CNT weight fraction in the final composites was 60±2 wt. %.

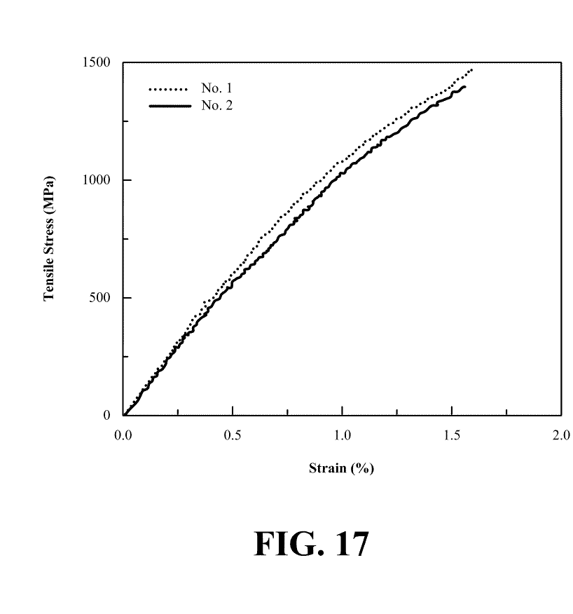

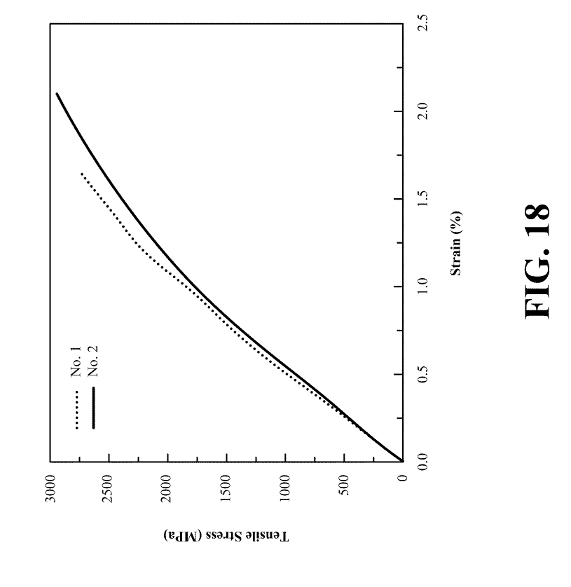

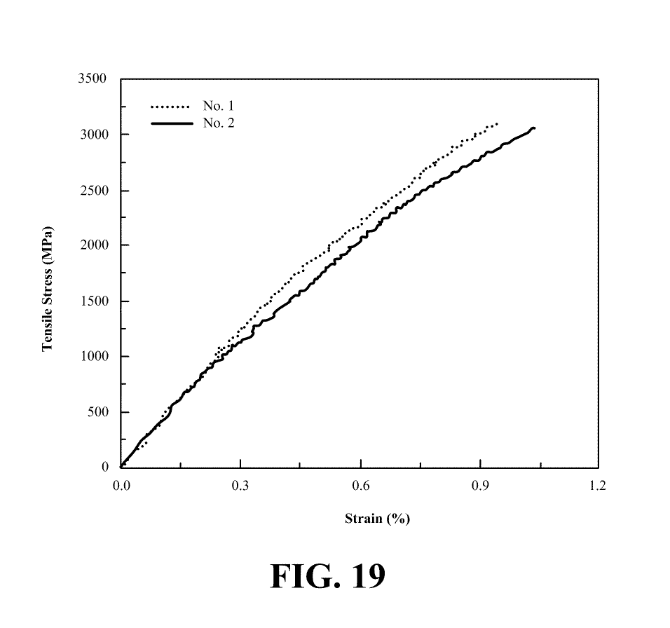

Characterization: Mechanical properties test were conducted using a Shimadzu machine with crosshead speed of 1 mm/min and the gauge length of 20 mm under room temperature. The strain ratio was recorded by Shimadzu non-contact video extensometer DVE-201. The specimens were cut into dog-bone shape with a length of 35 mm and thickness of 60 μm according to ASTM D638. The typical tensile stress-strain curves of functionalized CNT sheet/BMI composite are shown in FIGS. 17-19. After the tensile tests, the fracture surface morphology of the specimens was coated with a gold layer and observed using an electronic scanning microscope (JEOL JSM-7401F USA, Inc.). DMA was performed on a DMA 800 machine (TA instrument Inc.) using the film mode with a constant frequency of 1 Hz from room temperature to 400° C. with a heating rate of 5° C./min. The electrical conductivity of the functionalized CNT sheet/BMI composites was measured using a four-probe method.

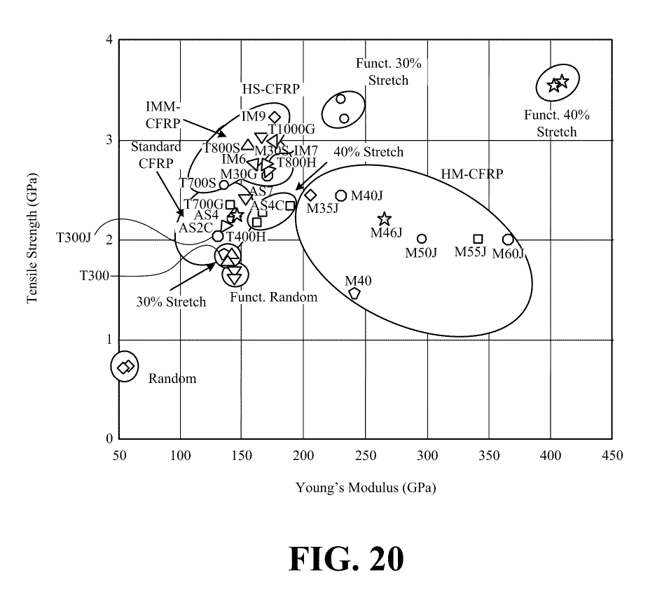

As shown in FIG. 20, the mechanical properties of pristine 40% stretch (stretched to a 40% strain to increase nanotube alignment) CNT sheet/BMI composites achieved the mechanical properties of standard UD carbon fiber reinforced composites, such as AS4 and T300 carbon fiber composites. After functionalization, the mechanical properties of functionalized 40% stretch alignment CNT sheet/BMI composites were improved to an even higher level. The Young's modulus exceeded that of highest-modulus carbon fiber composites, such as M60J epoxy composite, and the tensile strength was 15-20% higher than that of high-strength T1000G epoxy composites.

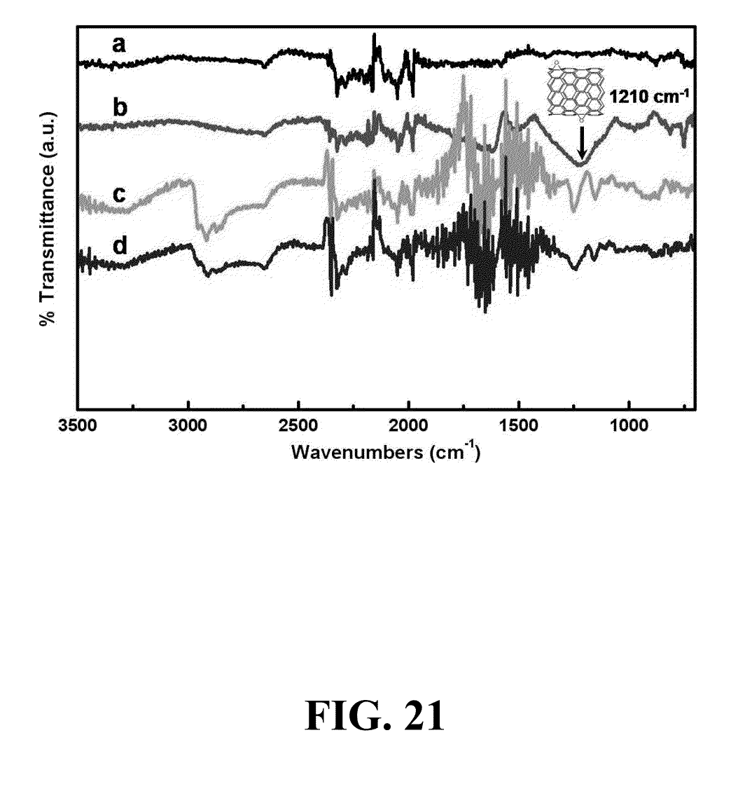

FIG. 21 is a graph of ATR-FTIR spectra of pristine CNTs, functionalized CNTs, and pristine and functionalized aligned (40% stretch) CNT sheet/BMI composites. The peak at 1210 cm⁻¹ was attributed to epoxy ring groups, which confirms the epoxide group successfully attached to the CNT structure. After curing with BMI resin (see Trace d), the peak at 1210 cm⁻¹ disappeared, which indicated the epoxy ring group reacted with BMI resin. The FTIR spectra of pristine CNT sheet/BMI composite is shown in Trace c. Both FTIR spectra were almost the same, which further confirms the epoxy rings on the CNT structures reacted to form covalent bonding with the BMI resin matrix.

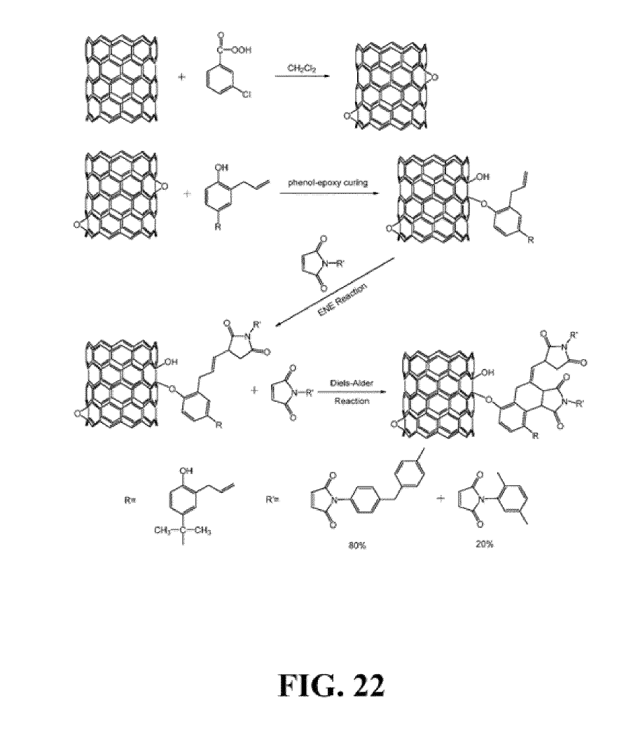

FIG. 22 shows the reaction mechanism. The epoxide groups of functionalized CNT first reacted with o,o′-diallyl bisphenol A in accordance with the mechanism of epoxy-phenol reaction. Then, the derivative reacted with the other two BMI components to form the three dimensional crosslinked structures through ENE and Diels-Alder reactions. The formation of carbon-oxygen bonds between CNT and BMI resin dramatically enhanced the interfacial bonding, and hence the load transfer efficiency was improved after functionalization.

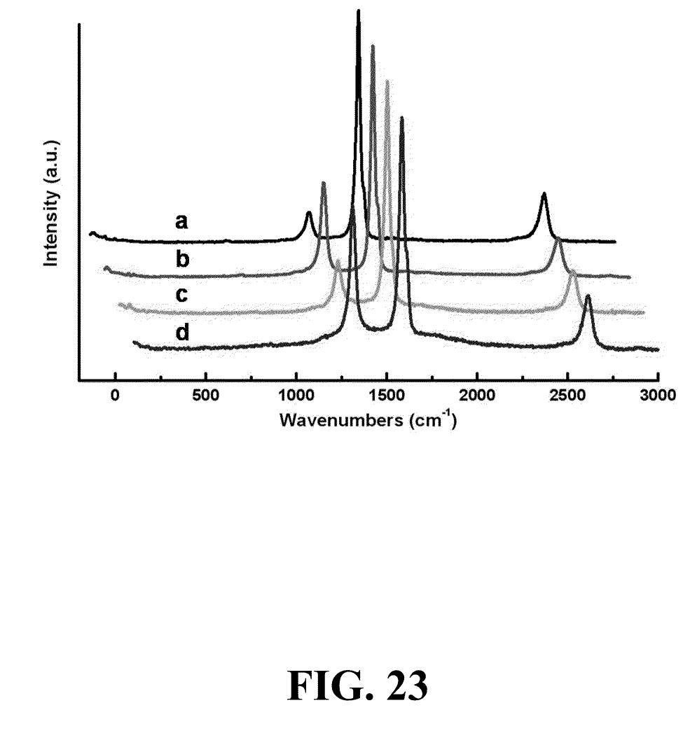

The curing mechanism was also studied using a Raman spectrometer. The intensity ratio of disorder band (D band at ˜1310 cm⁻¹) with G band (˜1580 cm⁻¹) of the functionalized CNT increased, which indicates the formation of epoxy rings on the structure of the CNTs, as shown in FIG. 23. The R-value (I_{D}/I_{G}) of pristine CNTs was 0.13. After functionalization, the I_{D}/I_{G} value increased up to 0.41. In the pristine CNT sheet/BMI composite, the I_{D}/I_{G} value increased to 0.23 due to the coupling effect of CNTs and BMI crosslinked structure. For funtionalized CNT sheet/BMI composite, the I_{D}/I_{G} further increased up to 0.62, which further indicates stronger interactions, possibly due to the formation of chemical bonding between the functionalized CNT with BMI resin.

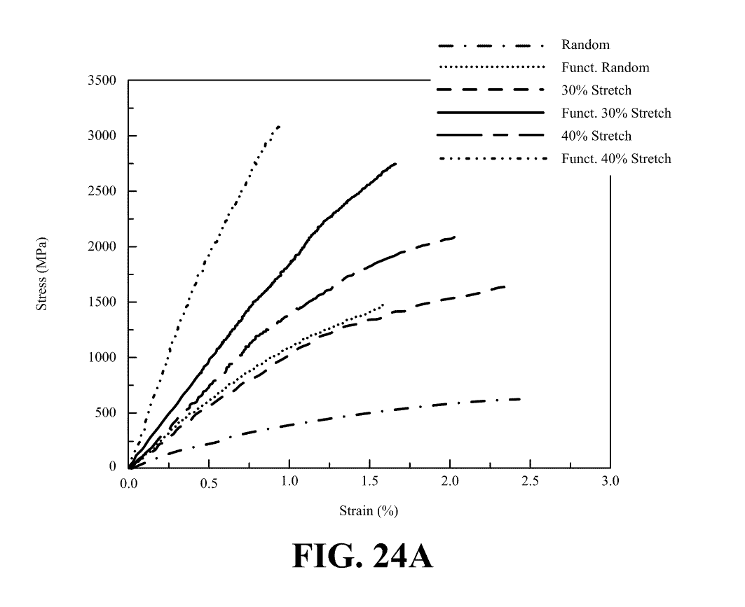

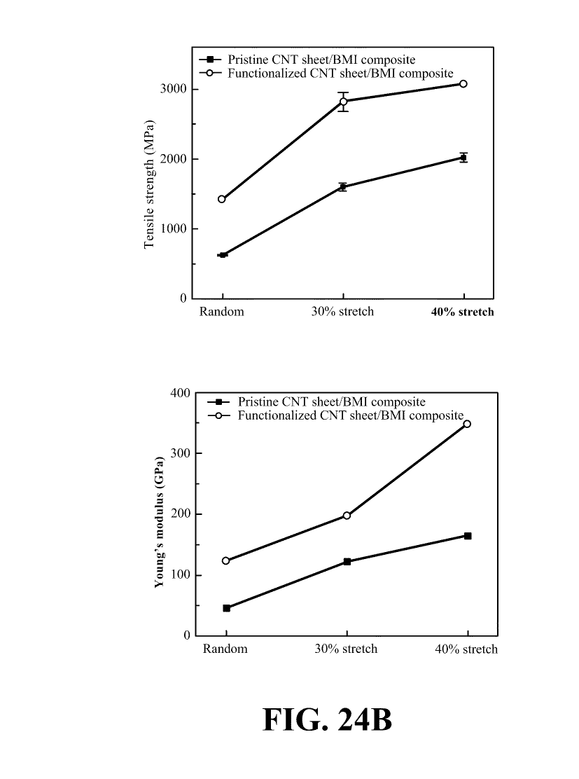

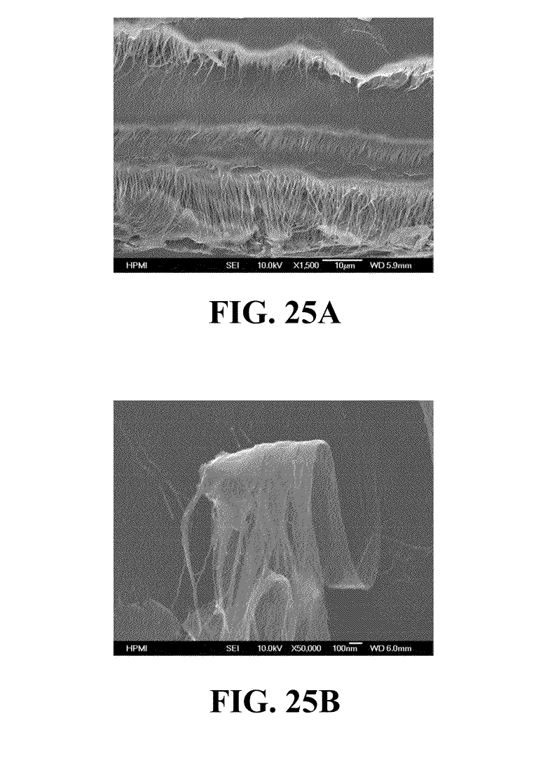

FIG. 24A shows the typical stress-strain curves of CNT sheets reinforced BMI nanocomposites along the nanotube alignment direction. FIG. 24B compares the detailed tensile strength and Young's modulus of the samples. For pristine random CNT sheet reinforced BMI nanocomposites, the tensile strength and Young's modulus dramatically increased as the alignment degree increased. The degree of nanotube alignment had a significant impact on the mechanical properties. The results show the degree of CNT alignment can reach as high as 80% along the stretching or alignment direction when the CNT sheets were stretched to a 40% strain. The tensile strength and Young's modulus of the resultant CNT sheet/BMI composites were as high as 2,088 MPa and 169 GPa, respectively.

After functionalization to introduce epoxide groups on the CNTs and then covalently bonding with the BMI resin matrix, the mechanical properties of the resultant nanocomposites were dramatically improved. The tensile strength and Young's modulus of functionalized random CNT sheet/BMI nanocomposites reached up to 1,437 MPa and 124 GPa, respectively, which is two times greater than that of pristine random CNT sheet/BMI nanocomposites previously reported. For functionalized 30% stretch alignment CNT sheet/BMI nanocomposites, the tensile strength and Young's modulus reached up to 2,843 MPa and 198 GPa, which is a 78% and 62% improvement above that of the pristine 30% stretch alignment CNT sheet/BMI nanocomposites. For functionalized 40% stretch alignment CNT sheet/BMI nanocomposites, the tensile strength and Young's modulus reached up to 3,081 MPa and 350 GPa, which are 48% and 107% improvements over that of pristine 40% stretch CNT sheet/BMI nanocomposites. However, the failure strain of functionalized CNT sheet/BMI nanocomposites decreased sharply, as shown in FIG. 24A. The failure strain of functionalized 40% stretch alignment CNT sheet/BMI nanocomposites dropped to 0.95%. This may be due to two possible reasons: (1) the formation of covalent bonding significantly reduced nanotube pullout and restricted nanotube network deformation capability and (2) possible nanotube structural damage due to the functionalization resulted in a loss of certain degree of ductility of the CNTs. Therefore, the degree of functionalization may need to be examined and optimized to improve strength and modulus without sacrificing failure strain. Here, the degree of functionalization was adjusted to 4% to minimize CNT damage and failure strain reduction of the composites.

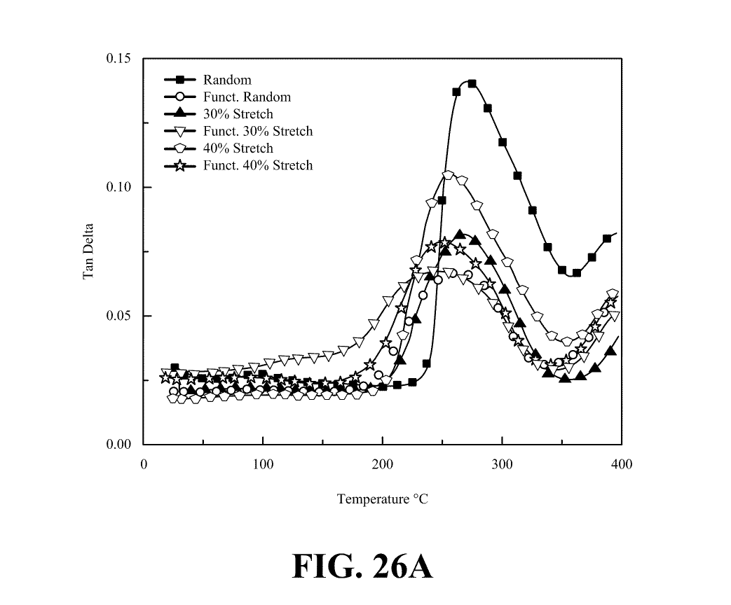

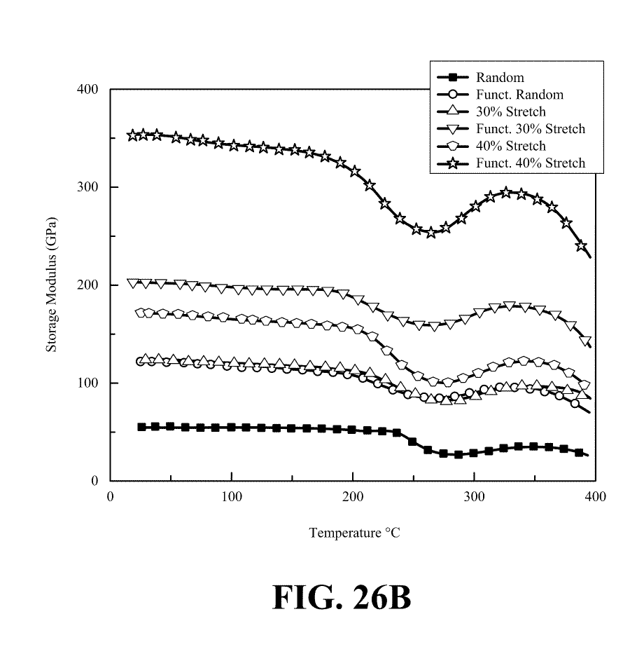

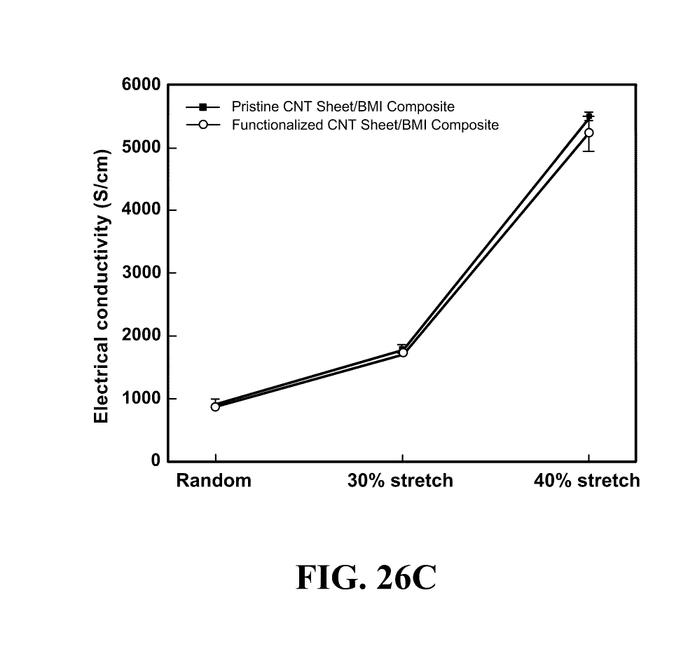

FIGS. 26A-B show the fracture surface morphology of a functionalized 40% stretch alignment composite after tensile testing. Rather than peeling off as seen in the pristine CNT sheet/BMI samples, it can be seen that BMI resin and aligned CNT layers adhered well due to good interfacial bonding. Although the interfacial bonding and load transfer efficiency were dramatically improved with this chemical functionalization, resulting in the high mechanical properties exceeding that of the state-of-the-art aerospace-grade unidirectional carbon fiber composites, many CNT slippage and pulled-out modes were still observed. Also, most of nanotubes were not broken after tensile testing.

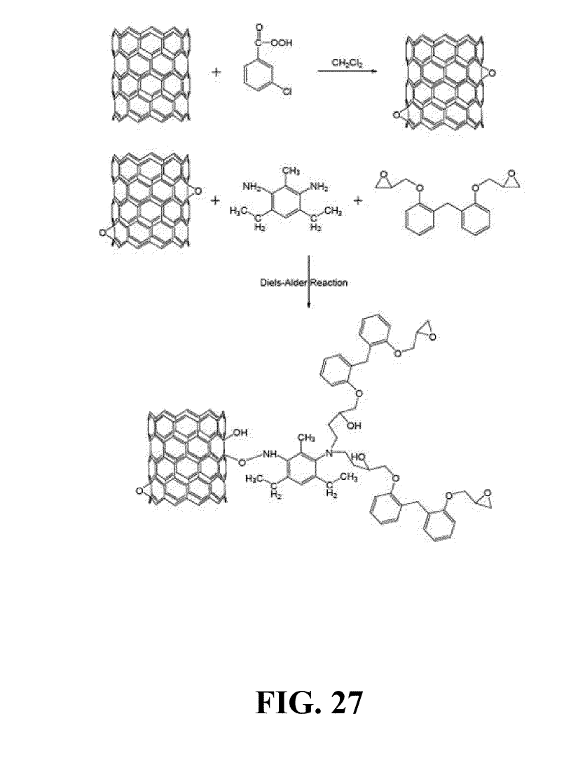

FIGS. 27A-B show dynamic mechanical analysis (DMA) results. Table 1 shows the storage modulus of the samples.

TABLE 1

| | Storage | |
|---|---|---|
| | Modulus | T_{g} |
| Specimen | (GPa) | (° C.) |
| Pristine random CNT sheet/BMI composite | 55 | 269.98 |
| Functionalized random CNT sheet/BMI composite | 122 | 262.67 |
| Pristine 30% stretch CNT sheet/BMI composite | 123 | 266.77 |
| Functionalized 30% stretch CNT sheet/BMI | 203 | 241.80 |
| composite | | |
| Pristine 40% stretch CNT sheet/BMI composite | 172 | 256.70 |
| Functionalized 40% stretch CNT sheet/BMI | 354 | 247.44 |
| composite | | |

The T_{g}s of all CNT sheet/BMI composites dropped due to the introduction of high loading of CNTs, which possibly reduced the crosslink density of the BMI resin matrix. Compared with pristine CNT sheet/BMI composites, the T_{g} of functionalized CNT composites further dropped, which may be due to the epoxide groups of functionalized CNTs reacting and consuming some functional groups of BMI resin, and hence further reducing crosslink density. However, the T_{g} drop of the functionalized CNT/BMI composites was only 23° C., and the composites still had a T_{g} of 247° C. for high temperature applications. Another side effect of chemical functionalization of CNTs is degradation of electrical conductivity. Usually, chemical functionalization will damage original CNT electronic structure and lower the electrical conductivity. In this Example, the degree of functionalization was at a lower level, 4%, to limit electrical conductivity degradation. FIG. 26C shows the comparison of electrical conductivities of CNT sheet/BMI composites with and without functionalization. The electrical conductivities of the functionalized CNT composites only show a small reduction, less than 5%, due to the lower degree of functionalization.

In summary, epoxide groups were introduced on CNT structures through epoxidation functionalization. The resultant CNT sheet/BMI composites demonstrated high performance beyond the state-of-the-art high strength and high modulus unidirectional carbon fiber composites for structural applications. The limited effect of CNT functionalization on T_{g} and electrical conductivity was observed due to a tailored low degree of functionalization. The results demonstrate great potential for utilizing CNTs to develop the next generation high-performance composites for wide structural and multifunctional applications.

### Example 3

Development of high mechanical properties of CNT reinforced epoxy composites was achieved by tailoring the DOF and improving alignment of CNTs having a mean length of at least 1 millimeter. The resultant composites showed an unprecedented integration of high strength and modulus, and large failure strain, compared to the state-of-the-art carbon fiber reinforced composites.

Randomly oriented CNT sheets supplied by Nanocomp Technologies Inc. were mechanically stretched using an AGS-J Shimadzu machine to substantially improve nanotube alignment. The aligned CNT sheets were placed in m-chloroperoxybenzoic acid (m-CPBA)/dichloromethane solutions for epoxidization functionalization, and then washed using dichloromethane to remove residual m-CPBA. The functionalized CNT sheets were placed into a vacuum oven set at 80° C. for 30 min to evaporate the residual dichloromethane. Finally, the CNT sheets were impregnated with a 10 wt. % epoxy resin solution in acetone to make individual CNT prepreg sheets with approximately 60% nanotube concentration or loading by weight. The concentration of epoxy resin in the solution was adjusted to ensure low viscosity for facilitating impregnation. Six prepreg layers were stacked together and cured by the hot-press with approximately 1 MPa pressure following the curing cycle: 200° F. for 30 min and then 350° F. for 4 hours. The CNT weight concentration or loading in the final composite samples was controlled in the range of 60±2 wt. %.

Millimeter-long (1-2 millimeter) nanotubes used in this example were in thin sheets (20-25 μm), provided by Nanocomp Technologies. Epoxide groups were introduced on the structure of CNT to directly functionalize the CNT sheet materials through epoxidation functionalization, as shown in FIG. 27A. Epoxide groups created on the CNTs were very active and participated in the curing reaction of epoxy resin to realize covalently bonding between the CNTs and epoxy resin matrix. The reaction mechanism between the functionalized CNTs and epoxy resin matrix is shown in FIG. 27A. The epoxy ring group was first introduced through functionalizing CNT sheets in m-CPBA/CH2Cl2 solutions. Then, the epoxy ring groups on the CNTs reacted with curing agent-diethyltoluenediamine (DETDA). Finally, the derivatives reacted with the Epon 862 molecules to form the three dimensional crosslinked structures through the Diels-Alder reaction.

DOF of the functionalized CNTs is defined as the ratio of the number of carbon atoms directly connected with oxygen atoms to the total number of carbon atoms of the CNT. To tailor the DOF values, m-CPBA/dichloromethane solutions of 0.5%, 1%, 2%, 5% and 10% by weight concentrations were made. The functionalization was conducted at room temperature (22-25° C.) by varying reaction times from 10 minutes to 30 hours. The CNT sheets were immersed into the solution for various periods of times, and removed to complete the functionalization without damaging sheet structural integrity. The DOF values were determined by the thermogravimetric analysis (TGA) in the range of 50-800° C. under nitrogen atmosphere.

Mechanical properties test were conducted using a Shimadzu machine with a crosshead speed of 1 mm/min and the gauge length of 20 mm under room temperature. The strain ratio was recorded by Shimadzu non-contact video extensometer DVE-201. The specimens were cut into dog-bone shapes at lengths of 35 mm and 60 μm thick, in accordance with ASTM D638. After the tensile tests, the fracture surface morphology of the specimens was coated with a gold layer and observed using an electronic scanning microscope (JEOL JSM-7401F USA, Inc.). The pristine aligned CNT sheet reinforced epoxy composite was cut perpendicular to the CNT alignment direction using Leica EM UC6/FC6 ultramicrotome (German) and observed by high resolution transmission electron microscopy Tecnai F30 (Philips, Holland).

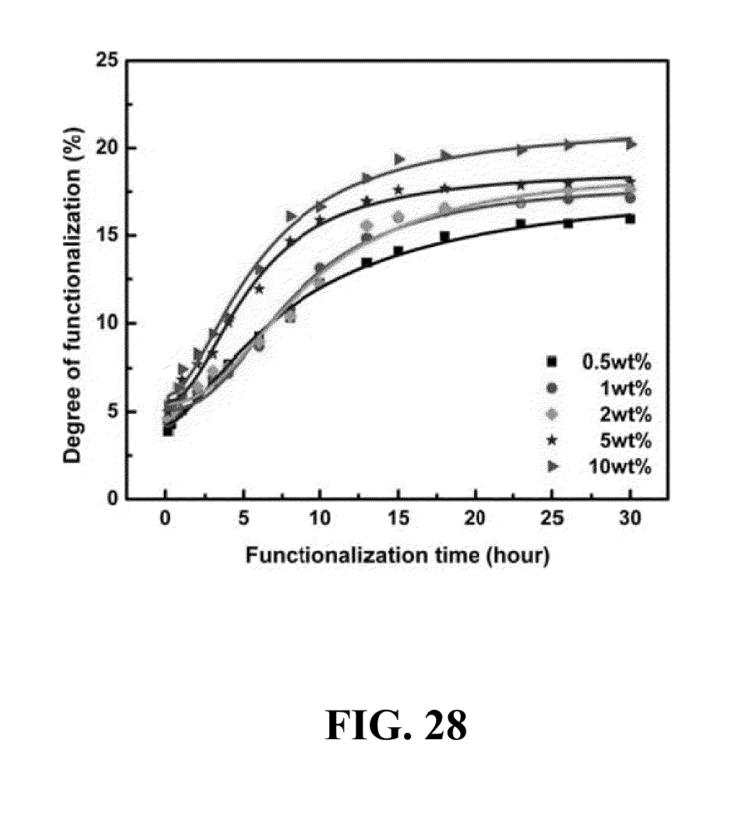

FIG. 28 shows the curves of DOF versus functionalization time and m-CPBA concentrations. For all cases, the DOF values initially increased rapidly with the reaction time and then reached an almost constant value. With the same treatment time, the DOF increased with the increase of m-CPBA concentration, indicating the desired DOF can be accurately tailored through adjusting reaction time and m-CPBA solution concentration. The goal of introducing the epoxy rings on the structures of CNTs is to facilitate creating covalent bonding between functionalized CNTs and epoxy resin matrix.

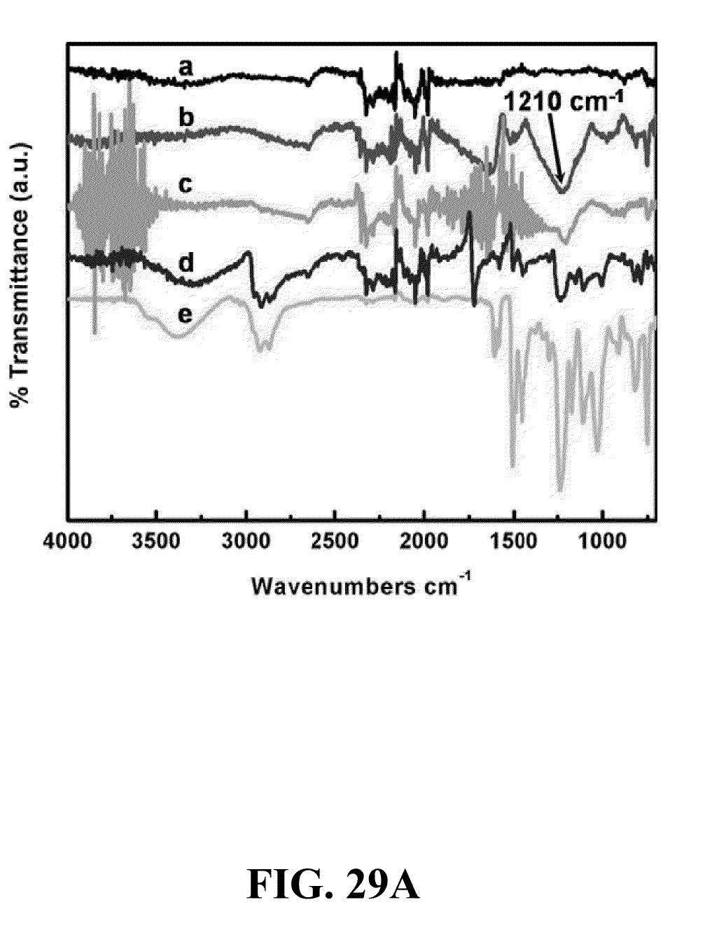

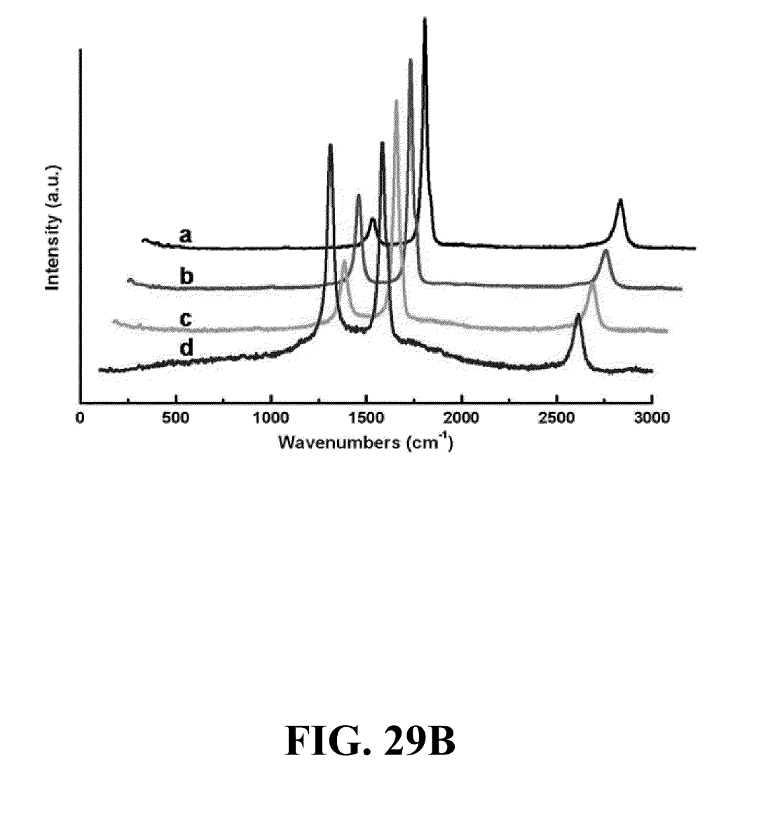

FIG. 29A shows the attenuated total reflection Fourier transform infrared (ATR-FTIR) spectrum comparison to verify the formation and reaction of the epoxide groups on functionalized CNTs ((a) pristine CNT, (b) functionalized CNT, (c) functionalized CNT sheet/epoxy composites, (d) pristine CNT sheet/epoxy nanocomposites and (e) cured neat epoxy resin.). Compared with pristine CNTs, the peak of 1210 cm⁻¹ of functionalized CNTs was assigned to the carbon oxygen stretching frequency of epoxide moiety as seen in Trace b. After curing with epoxy resin, this peak became smaller, showing that the epoxy ring groups on the CNT reacted with epoxy resin, as seen in Trace c. The ATR-FTIR spectra of pristine CNT sheet/epoxy composite and pure epoxy resin are shown as Traces d and e. The peak of 1210 cm⁻¹ still existed in the pristine CNT sheet/epoxy composites due to residual epoxy group of EPON 862 (epoxy resin matrix), same as Trace e of pure cured epoxy resin with the same curing cycle.

Raman spectrometer was used to verify the proposed reaction mechanism. As shown in FIG. 29B, the R-value (I_{D}/I_{G}) of pristine CNT of 0.13 indicated that the quality of CNT was very good with a lower defect density ((a) pristine CNT, (b) functionalized CNT, (c) pristine CNT sheet/epoxy composite and (d) functionalized CNT sheet/epoxy composite). After functionalization, the I_{D}/I_{G} value increased up to 0.41, which indicates epoxy rings formed on the structures of the CNT. For the pristine CNT sheet/epoxy composite, the I_{D}/I_{G} value increased to 0.30 due to the coupling with cured epoxy crosslinked networks. For functionalized CNT sheet/epoxy composites, the I_{D}/I_{G} value further increased up to 0.99, which further indicated much stronger interactions between the CNTs and resin matrix due to the formation of chemical bond between the functionalized CNT with the epoxy resin matrix.

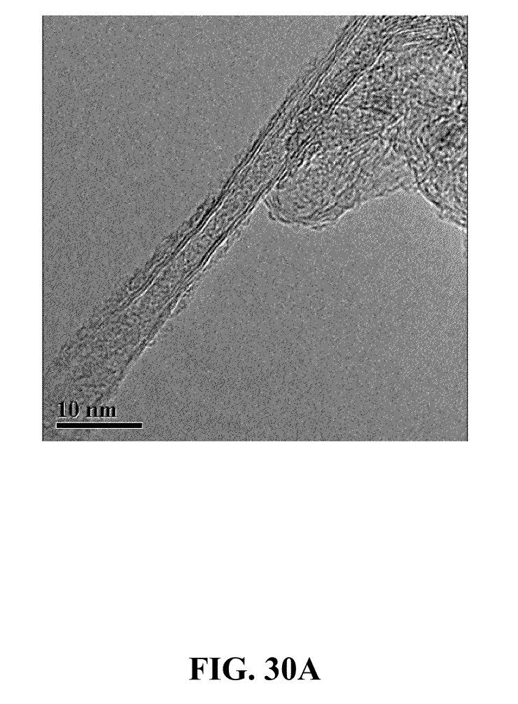

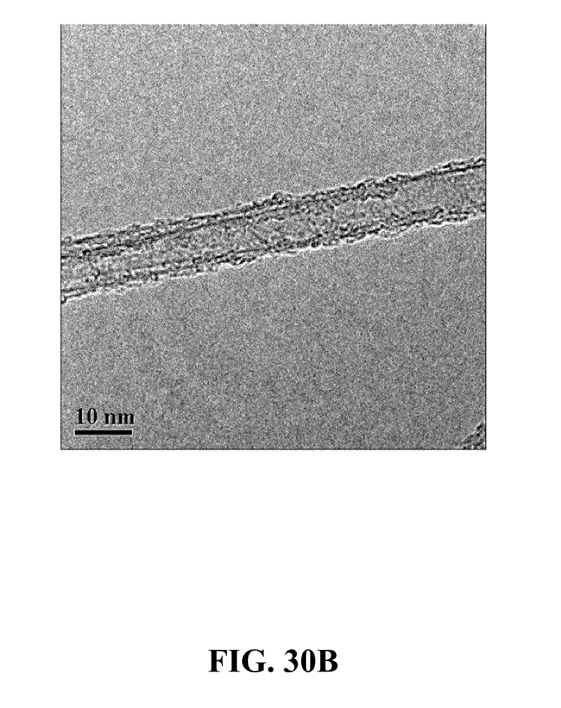

To further confirm the reaction mechanism, the high resolution transmission electron microscopy (HRTEM) was conducted to observe the nanotube surface structure before and after functionalization, shown in FIG. 30A (pristine double-walled nanotube) and FIG. 30B (functionalized double-walled nanotube). Most of nanotubes used in this example were double-wall nanotubes. After functionalization, the epoxide groups were attached on the outside wall which resulted in the roughness of the nanotube, seen FIG. 30B.

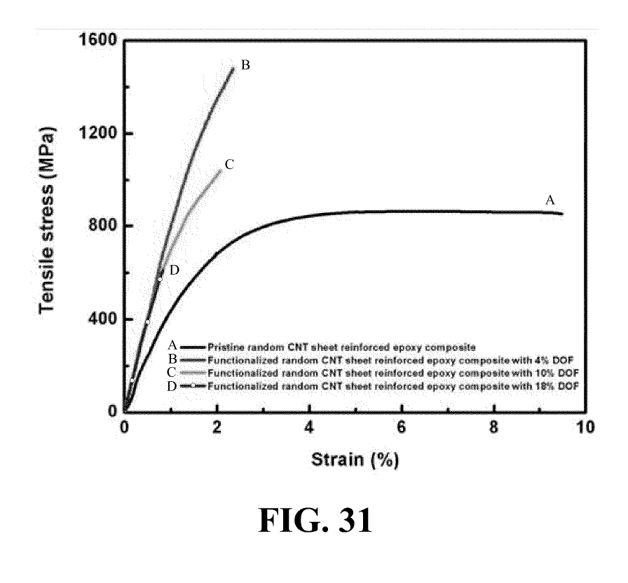

To study the effect of different DOF on the mechanical properties of nanocomposites, the DOF values of random CNT sheets were tailored to 4%, 10% and 18%. FIG. 31 shows the mechanical properties of resultant nanocomposites. For the pristine random CNT sheet nanocomposites, the tensile strength and Young's modulus were 851 MPa and 45 GPa, respectively. After functionalization, the Young's modulus of CNT sheet nanocomposite increased. However, for all three different DOB, the Young's modulus was almost the same at 80 GPa. The effects of interfacial bonding enhancement between nanotubes and epoxy resin on load transfer efficiency may be at the same level for all three cases. However, the tensile strength of resultant nanocomposites with higher DOF values decreased, which indicates the high DOF damages the CNT structure and degrades the CNT mechanical properties. The 4% DOF is likely adequate to substantially enhance load transfer between epoxy resin and functionalized CNTs without large strength degradation in the resultant nanocomposites.

To quantify load transfer efficiency improvement, a DOF-load transfer efficiency model was proposed. The modified rule of mixtures (ROM) equation is used for predicting properties of discontinuous short fiber reinforced polymer composite, which assumes a perfect load transfer efficiency between fibers and resin matrix. That is not true for CNT reinforced nanocomposites, as evidenced by many CNT pullout without breaks and very low mechanical performance. Thus, the modified the rule of mixture was used to consider load transfer efficiency effect, as shown in Equation (2).

E_{c}=η₀·η_{L}·η_{B}·V_{f}·E_{f}+(1−V_{f})·Eₘ Equation 2.

where E_{c}, Eₘ, and E_{f} are Young's moduli of the resultant composites, matrix and fiber, respectively. V_{f} is the volume fraction of the CNTs. The orientation factor, η₀, was introduced to account for fiber orientation effect, which equals to 1 for fully aligned fibers. For randomly oriented fibers, the η₀ value was 0.33. The length efficiency factor, η_{L}, was introduced to account for the efficiency of load transfer from the matrix to the fibers due to aspect ratio effect. η_{L} can vary between 0 and 1.

In this example, the length of the CNTs was approximately at the millimeter level, which is much larger than the diameters (3-8 nm) of the CNTs; therefore, η_{L} as 1. Herein, the interfacial loading transfer efficiency factor, η_{B}, was defined and used to account for load transfer efficiency determined by interfacial bonding quality between fiber and matrix. Equation (2) was changed into a logarithmic form to obtain Equation (3)

lg(E_{c}−(1−V_{f})·Eₘ)=lg(η_{B})−lg(η₀·η_{L})−lg(V_{f}·E_{f}) Equation 3.

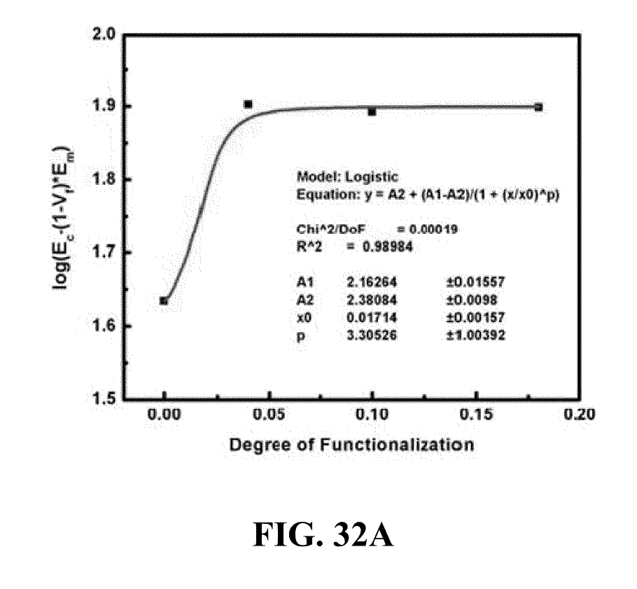

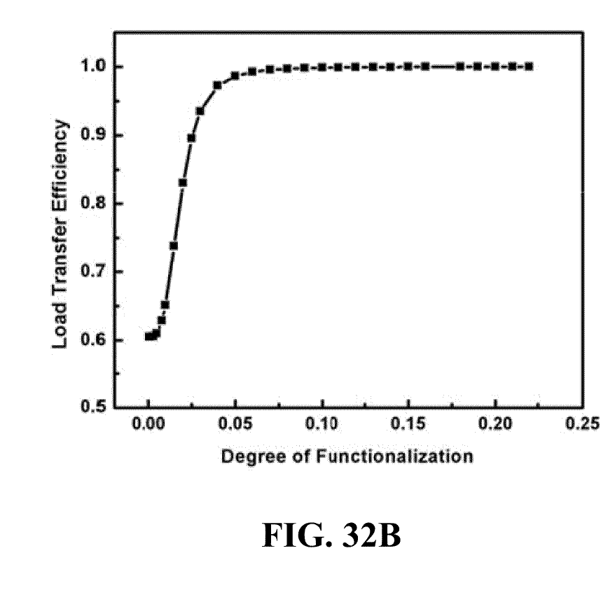

Assuming η_{B} is a function of DOF, then utilizing the results shown in FIG. 31, the curve of lg(E_{c}−(1−V_{f})·Eₘ) versus DOF, as shown in FIG. 32A. Through logistic fitting, the relationship between η_{B} and DOF directly can be shown, as seen in Equation (4) and FIG. 32B.

$${η}_{B} = {10}^{\frac{- 0.2182}{1 + 6. S7 \times {10}^{1} \times {( DOF )}^{3.3}}} . \qquad Equation 4$$

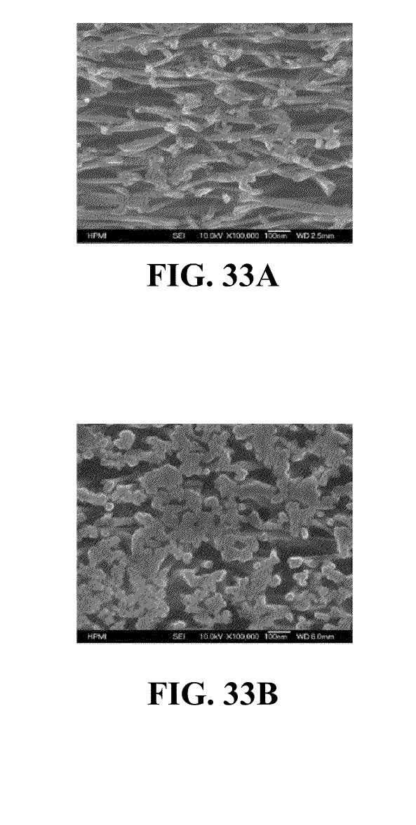

If DOF=0 and the η_{B,0}=0.605, which means the load transfer efficiency induced by nonbinding interfacial interactions is only 60.5% for the pristine CNT sheet of millimeter long nanotubes. If DOF=0.04, then η_{B,0.04}=0.972, which means the load transfer efficiency is adequate. It also shows that η_{B} dramatically increased with the increase of DOF values at the beginning, then tended to become constant and saturated, which was in good agreement with other simulation results. Nanotube alignment is another factor to consider in realizing high mechanical properties as previously discussed. The sheets of randomly oriented long CNTs were stretched to about 40% strain to realize an alignment of ˜80% of the CNTs along the stretch direction, as determined by polarized Raman analysis. The cross-section of random and aligned CNT sheets are shown in FIG. 33A (random) and FIG. 33B (aligned). After stretching, most nanotubes assembled along the stretching direction very well, which further verified ˜80% alignment degree determined by polarized Raman analysis.

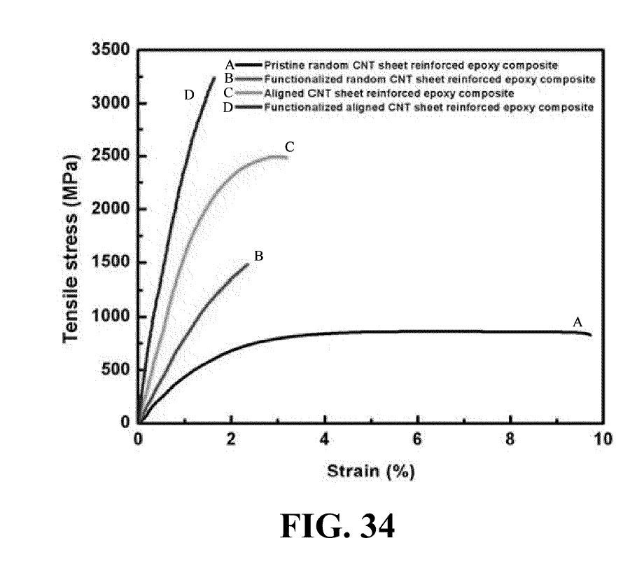

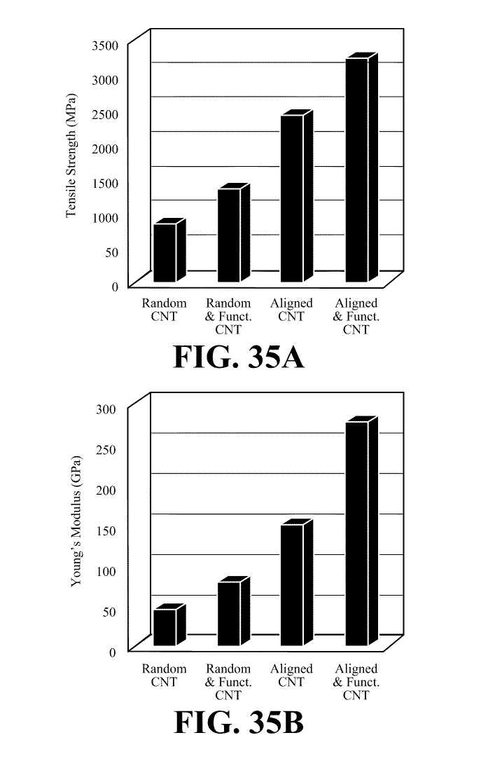

The highly aligned CNT sheet was further functionalized with a tailored DOF of 4% to achieve a better performance of CNT reinforced epoxy composites. FIG. 34 shows the typical stress-strain curves of CNT sheet reinforced epoxy nanocomposites with/without alignment and functionalization. After functionalization, the tensile strength and Young's modulus of the random CNT sheets nanocomposites increased to 1333 MPa and 80 GPa, respectively, as shown in FIG. 35. Such performance is comparable to carbon fiber fabric composites. It is worth noting that the tensile failure strain of the pristine random CNT sheet nanocomposites reached 8.21%, which is much higher than that (3.5-5%) of conventional carbon fiber fabric composites. Two possible reasons are attributed to this: (1) the pure randomly oriented CNT sheets have good deformation ability due to entanglements and slippages in the randomly oriented networks of long CNTs; and (2) possible interface slippage between CNT and resin matrix can allow large deformations of the CNT networks within the composites. After functionalization, the interfacial bonding were dramatically enhanced due to the formation of chemical bonding between CNTs and epoxy resin, which greatly constrains the slippage between CNT and epoxy resin and result in the low failure strain of resultant nanocomposites.

The tensile strength, Young's modulus and failure strain of the aligned CNT composites were 2,375 MPa, 153 GPa and 3.2%, respectively. These results exceeded the mechanical properties of AS4 unidirectional carbon fiber epoxy composites. The failure strain was double that of AS4 composites. After functionalization, the tensile strength and Young's modulus increased to 3,252 MPa and 279 GPa, respectively. This is 80% and 250% higher than the tensile strength and Young's modulus of coagulation-spun, single-walled carbon nanotubes/polyvinyl alcohol composite fiber previously reported. The failure strain of functionalized aligned CNT nanocomposites dropped to 1.6% from 3.2% due to the chemical bond formation between CNT and epoxy resin. Based on this measured Young's modulus of aligned and functionalized CNT sheet reinforced epoxy composite, an orientation factor η₀=0.8 can be had, according to the results of Polarized Raman spectra analysis, and a load transfer efficiency factor of η_{B}=0.972 as previously discussed.

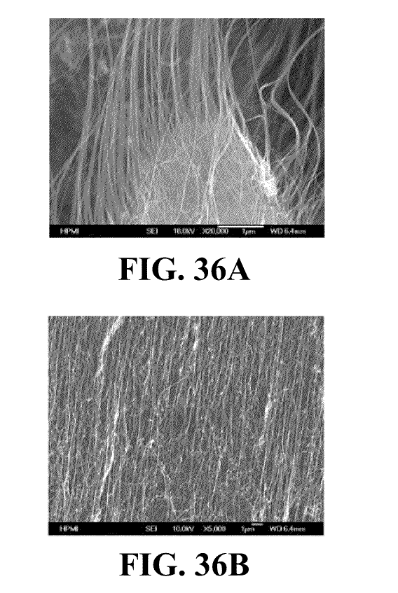

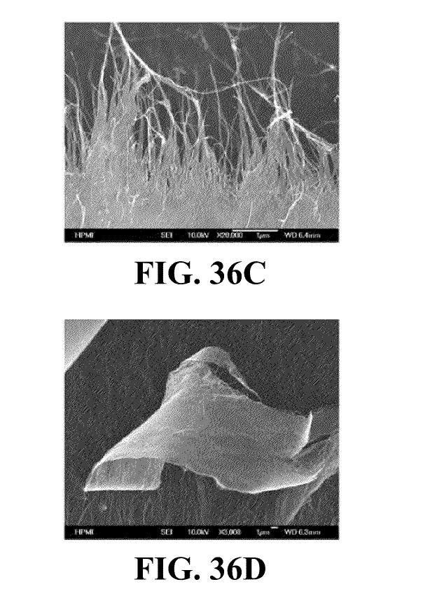

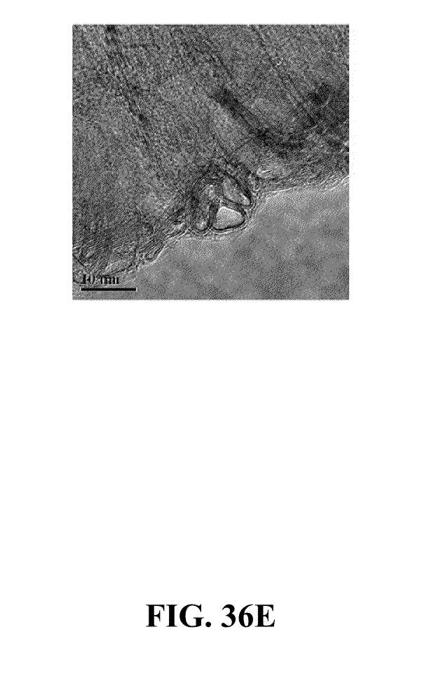

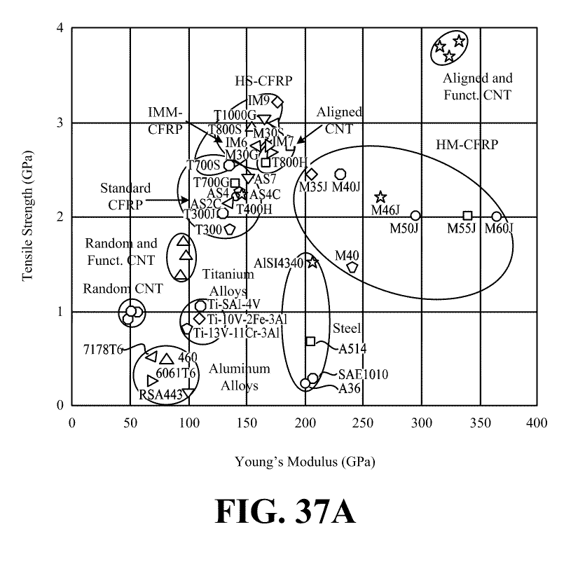

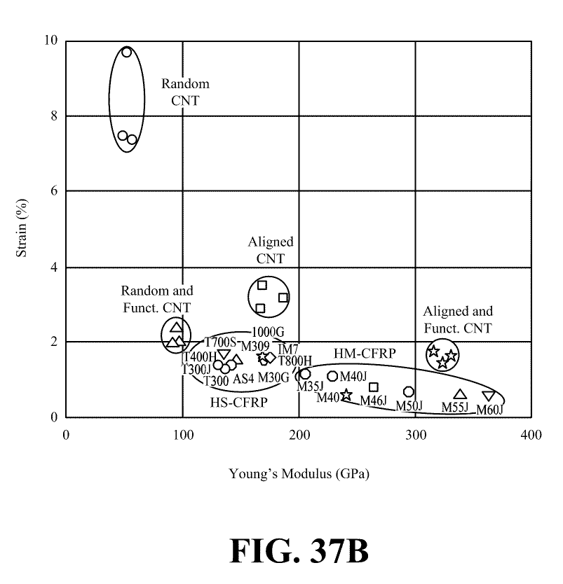

Hence, Equation (2) can be used to calculate the Young's modulus of CNT bundles. The result was 714 GPa, which is consistent with the experimental values reported in literature. FIG. 36A shows the fracture surface morphology of pristine aligned CNT sheet reinforced epoxy composite specimen after tensile tests. No broken nanotubes were observed. FIG. 36B shows the nanotubes separated from the epoxy resin, which indicates the poor interfacial bonding between pristine CNT and epoxy resin. After functionalization, some of broken nanotubes can be observed at the fracture surface of the functionalized aligned CNT sheet/epoxy composite, as shown in FIG. 36C, indicating better interfacial bonding. FIG. 36D shows a heavily curved thin film formed of functionalized CNTs well bonded with epoxy resin peeled from the fracture surface, further illustrating interfacial bonding improvement. FIG. 36E is the HRTEM image of cross-section of pristine aligned CNT sheet reinforced epoxy composites. Most double-walled nanotubes collapsed into “dog-bone” shape and stacked very well along the alignment direction. The results reveal the intertube frictional force can be increased by a maximum factor of 4, when all tubes collapse and the bundle remains collapsed. Furthermore, the bundle will become stronger due to the significant decreasing of overall cross-sectional area for the collapsed structure. Herein, the collapsed double-walled nanotubes were observed in the pristine aligned CNT sheet reinforced epoxy composite. One reason for collapse may be the high pressure in the press of fabricating the composites. These collapsed nanotubes packed very well, which resulted in high CNT loading and high mechanical properties of CNT sheet reinforced epoxy composites. Normalized to 60% reinforcement volume fraction, the tensile strength of the functionalized and aligned CNT composites was 10-20% higher than the state-of-the-art high-strength unidirectional structural CFRP systems, such as unidirectional T1000G composites, as shown in FIG. 37A, and about 5×, 3×, and 2× greater than that of aluminum alloys, titanium alloys, and steels for structural applications, respectively. The Young's modulus of the resultant CNT composites was two times higher than typical unidirectional AS4, IM7, T300, T700 and T1000 CFRPs, and close to the best high-modulus CFRP systems (M55J and M60J graphite fiber composites). The strain of this nanotube composite was twice that of the CFRP systems at the same level of Young's modulus, as seen FIG. 37B, which is an improvement toward developing more resilient composites. The measured density of our CNT composites was 1.53 g/cm³, slightly less than carbon fiber composites.

Thus, a new class of resilient, high-mechanical performance nanotube composites may be provided by utilizing extra-large aspect ratio CNTs, optimizing alignment and improving interfacial bonding. These composites will lead to uncompromised design freedom and unprecedented performance advantages for engineered systems in aerospace, automotive, medical devices and sporting goods industries. Advantages include weight reduction, high stiffness and strength, great resilience and toughness for improved damage tolerance and structural reliability, as well as high electrical and thermal conductivity for multifunctional applications.

Publications cited herein are incorporated by reference. Modifications and variations of the methods and devices described herein will be obvious to those skilled in the art from the foregoing detailed description. Such modifications and variations are intended to come within the scope of the appended claims.

We claim:

1. A method for functionalizing a network of nanoscale fibers comprising:
contacting the network of nanoscale fibers with an oxidant to graft at least one epoxide group to at least a portion of the network of nanoscale fibers.

2. The method of claim 1, wherein contacting is at a temperature ranging from 20° C. to 50° C.

3. The method of claim 1, wherein the network of nanoscale fibers is a buckypaper.

4. The method of claim 1, wherein the nanoscale fibers are carbon nanotubes.

5. The method of claim 1, wherein the oxidant comprises a peroxyacid.

6. The method of claim 5, wherein the peroxyacid is in a peroxyacid solution.

7. The method of claim 6, wherein the step of contacting comprises immersing the network of nanoscale fibers into the peroxyacid solution.

8. The method of claim 6, wherein the peroxyacid is present in the peroxyacid solution in an amount ranging from 0.05 wt. % to 30 wt. %.

9. The method of claim 1, wherein the contacting is for a time period less than 3 hours.

10. A method for making a composite comprising:
providing a network of functionalized nanoscale fibers, wherein at least a portion of the network of functionalized nanoscale fibers has been functionalized by contact with an oxidant; and
combining the network of functionalized nanoscale fibers with a matrix material to form a composite.

11. The method of claim 10, wherein the network of nanoscale fibers is a buckypaper.

12. The method of claim 10, wherein the nanoscale fibers are carbon nanotubes.

13. The method of claim 10, wherein the oxidant comprises a peroxyacid.

14. The method of claim 10, wherein the matrix material comprises a resin.

15. The method of claim 14, wherein the resin comprises an epoxy resin.

16. The method of claim 15, wherein the network of functionalized nanoscale fibers comprises at least one epoxide group, and wherein the at least one epoxide group reacts with the epoxy resin to bond the epoxy resin to the nanoscale fibers.

17. An article comprising:
a network of nanoscale fibers, wherein the network comprises nanoscale fibers having at least one epoxide group grafted onto at least a portion of the nanoscale fibers.

18. The article of claim 17 further comprising a matrix material dispersed on and/or within the network of nanoscale fibers.

19. The article of claim 18, wherein the matrix material comprises an epoxy resin bonded to the at least one epoxide group.

20. The article of claim 18, wherein the article has a Young's modulus ranging from 47 GPa to 350 GPa.

21. The article of claim 18, wherein the article has a tensile strength ranging from 620 MPa to 3252 MPa.

22. The article of claim 17, wherein the network of nanoscale fibers comprise a buckypaper.

23. The article of claim 17, wherein the nanoscale fibers comprise carbon nanotubes having a mean length of at least 1 millimeter.
